(19) United States
(12) Patent Application Publication
(10) Pub. No.: US 2024/0066696 A1
(43) Pub. Date: Feb. 29, 2024

(54) ROBOT SYSTEM, CONTROL METHOD, AND PASSIVE ARM

(71) Applicant: KAWASAKI JUKOGYO KABUSHIKI KAISHA, Kobe-shi, Hyogo (JP)

(72) Inventors: Shinichi FUJISAWA, Kobe-shi (JP); Junji ITO, Kobe-shi (JP)

(73) Assignee: KAWASAKI JUKOGYO KABUSHIKI KAISHA, Kobe-shi, Hyogo (JP)

(21) Appl. No.: 18/268,334

(22) PCT Filed: Dec. 17, 2021
(86) PCT No.: PCT/JP2021/046801

§ 371 Date: Jun. 20, 2023

(30) Foreign Application Priority Data
Dec. 21, 2020 (JP) 2020-211593
Dec. 21, 2020 (JP) 2020-211594

(51) Int. Cl. B25J 9/16; B25J 9/00

(52) U.S. Cl. CPC B25J 9/1664; B25J 9/0087

(57) ABSTRACT

A robot system includes: a robotic arm; a passive arm which is coupled to and uncoupled from the robotic arm and is operated by the robotic arm; and a controller which controls first and second operations of the robotic arm. The first operation of the robotic arm is an operation that acts on a target object. The second operation of the robotic arm is an operation of causing the passive arm to act on the target object. In the second operation, the controller executes: coupling the robotic arm and the passive arm; causing the robotic arm to operate the passive arm to engage the passive arm with the target object; and causing the robotic arm to operate the passive arm, which has engaged with the target object, to operate the target object.

### CROSS-REFERENCE TO RELATED APPLICATIONS

This application claims priority to and the benefit of Japanese Patent Application Nos. 2020-211593 and 2020-211594 filed on Dec. 21, 2020, the entire disclosures of which are incorporated herein by reference.

### TECHNICAL FIELD

The present disclosure relates to a robot system, a control method, and a passive arm.

### BACKGROUND ART

In recent years, robots are used for various purposes. For example, Japanese Laid-Open Patent Application Publication No. 2013-31890 discloses a painting system for vehicle bodies. The painting system includes: a door open/close robot that opens and closes a door of the vehicle body and maintains an open state of the door; and a painting robot that can paint an inside of the door of the vehicle body.

### SUMMARY OF INVENTION

According to the painting system disclosed in Japanese Laid-Open Patent Application Publication No. 2013-31890, each of the painting robot and the door open/close robot includes an active arm that can operate by itself. Since the active arms are included for two types of work, the cost increases.

An object of the present disclosure is to provide a robot system, a control method, and a passive arm which can realize cost reductions.

A robot system according to one aspect of the present disclosure includes: a robotic arm; a passive arm with two or more degrees of freedom, the passive arm being coupled to and uncoupled from the robotic arm, the passive arm including an engaging structure that engages with a target object, the passive arm being operated by the robotic arm coupled to the passive arm; and a controller configured to control first and second operations of the robotic arm. The first operation of the robotic arm is an operation in which the robotic arm acts on the target object. The second operation of the robotic arm is an operation in which the robotic arm causes the passive arm to act on the target object. In the second operation, the controller executes: coupling the robotic arm and the passive arm; causing the robotic arm to operate the passive arm to engage the engaging structure with the target object; and causing the robotic arm to operate the passive arm, which has engaged with the target object, to operate the target object.

### BRIEF DESCRIPTION OF DRAWINGS

FIG. 1 is a perspective view showing one example of the configuration of a robot system according to an embodiment.

FIG. 2 is a perspective view showing one example of the configuration of the robot system according to the embodiment.

FIG. 3 is a perspective view showing one example of the configuration of a first painting robot according to the embodiment.

FIG. 4 is a perspective view showing one example of the configuration of a second painting robot according to the embodiment.

FIG. 5 is a side view showing one example of the configuration of a first passive arm.

FIG. 6 is a top view showing one example of the configuration of the first passive arm.

FIG. 7 is a front view showing one example of the configuration of a second passive arm.

FIG. 8 is a side view showing one example of the configuration of the second passive arm.

FIG. 9 is a block diagram showing one example of the configurations of first to third controllers and their peripheries according to the embodiment.

FIG. 10 is a block diagram showing one example of the functional configurations of the first and second controllers according to the embodiment.

FIG. 11 is a flowchart showing one example of an opening operation of the robot system according to the embodiment.

FIG. 12 is a flowchart showing one example of a closing operation of the robot system according to the embodiment.

### DESCRIPTION OF EMBODIMENTS

Hereinafter, an exemplary embodiment of the present disclosure will be described with reference to the drawings. The embodiment described below is a comprehensive or specific example. Among components in the following embodiment, components that are not recited in independent claims which embody the broadest concept of the present disclosure will be described as optional components. The diagrams in the attached drawings are schematic diagrams and are not necessarily strictly drawn. In the diagrams, the same reference signs are used for the substantially identical components, and the repetition of the same explanation may be avoided, or such explanation may be simplified. Moreover, in the present description and the claims, a “device” may denote not only a single device but also a system including devices.

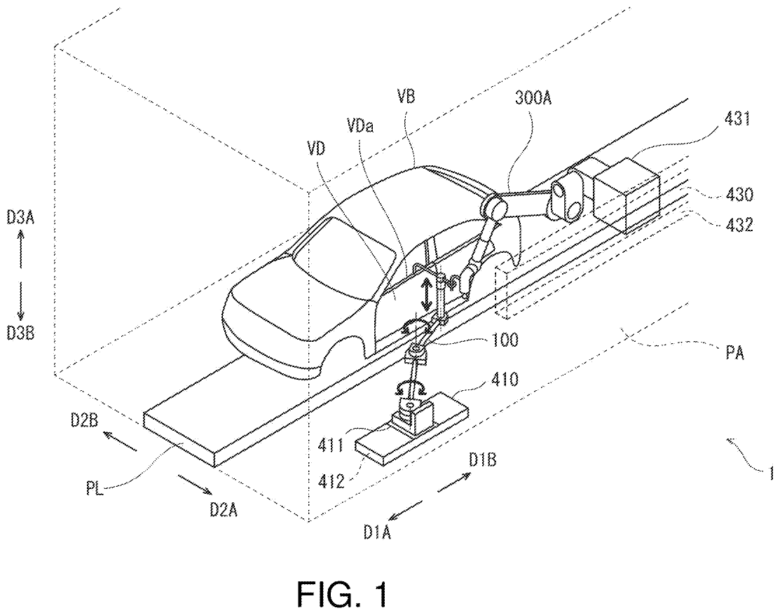

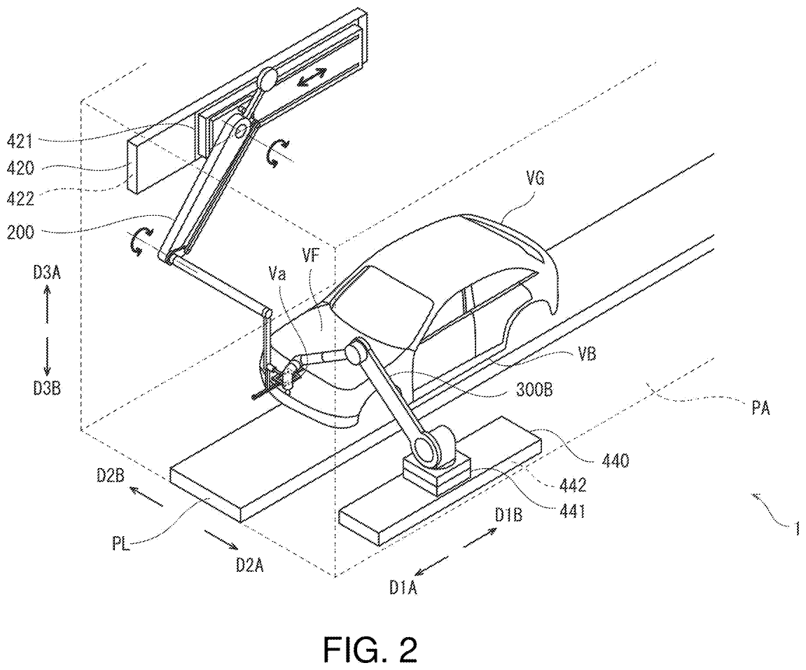

Configuration of Robot System One example of the configuration of a robot system 1 according to the exemplary embodiment will be described with reference to FIGS. 1 and 2. FIGS. 1 and 2 are perspective views each showing one example of the configuration of the robot system 1 according to the embodiment. The following will be described on the basis that in the present embodiment, the robot system 1 is a system that performs painting work of a vehicle body VB in an automobile manufacturing factory. However, the use of the robot system 1 is not limited to the painting work. The vehicle body VB is one example of a target object.

The robot system 1 is located at a painting area PA. The painting area PA is surrounded by a wall, a ceiling, and the like. A painting line apparatus PL that carries the vehicle body VB, which is subjected to painting, in a direction D1A is located at the painting area PA. The direction D1A is a direction along a floor surface of the painting area PA and is, for example, a horizontal direction. The configuration of the painting line apparatus PL is not especially limited and may be a known configuration. Examples of the painting line apparatus PL include: an apparatus that carries the vehicle body VB by a conveyor; and an apparatus that carries the vehicle body VB along a track.

The robot system 1 includes: one or more first passive arms 100; one or more second passive arms 200; one or more first painting robots 300A; one or more second painting robots 300B; one or more movers 410 for the one or more first passive arms 100; one or more movers 420 for the one or more second passive arms 200; one or more movers 430 for the one or more first painting robots 300A; one or more movers 440 for the one or more second painting robots 300B; and controllers 500A to 500C.

The one or more first passive arms 100, the one or more second passive arms 200, the one or more first painting robots 300A, the one or more second painting robots 300B, and the movers 410 to 440 are located at the same painting area PA and can perform work related to the painting of the same vehicle body VB. For convenience of the drawings, some of the above components are shown in FIG. 1, and the others are shown in FIG. 2. FIG. 1 shows the one or more first passive arms 100, the one or more first painting robots 300A, and the movers 410 and 430. FIG. 2 shows the one or more second passive arms 200, the one or more second painting robots 300B, and the movers 420 and 440. In the present embodiment, the above components are located in the same space.

Although not shown in FIG. 1, in the present embodiment, two first passive arms 100 are respectively located in side directions D2A and D2B with respect to the painting line apparatus PL, and two first painting robots 300A are respectively located in the side directions D2A and D2B with respect to the painting line apparatus PL. The first passive arms 100 are located on the floor surface of the painting area PA, and the first painting robots 300A are located on wall surfaces of the painting area PA. The first painting robot 300A can use the first passive arm 100 to paint a door VD of the vehicle body VB and an inner portion of the door VD. The door VD is one example of a first opening/closing part.

The directions D2A and D2B are directions opposite to each other. The directions D2A and D2B are directions perpendicular to the directions D1A and D1B and along the floor surface of the painting area PA, and are, for example, horizontal directions. Directions D3A and D3B are directions opposite to each other. The directions D3A and D3B are directions perpendicular to the directions D1A, D1B, D2A, and D2B and perpendicular to the floor surface of the painting area PA, and are, for example, vertical directions. The directions D3A is an upper direction, and the direction D3B is a lower direction.

In the present embodiment, one second passive arm 200 is located in the direction D2B with respect to the painting line apparatus PL, and one second painting robot 300B is located in the direction D2A with respect to the painting line apparatus PL. The second passive arm 200 is located on the wall surface of the painting area PA, and the second painting robot 300B is located on the floor surface of the painting area PA. The second painting robot 300B can use the second passive arm 200 to paint a front hood VF of the vehicle body VB, an inner portion of the front hood VF, a rear gate VG of the vehicle body VB, and an inner portion of the rear gate VG. The rear gate VG may include a rear trunk hood and the like. Each of the front hood VF and the rear gate VG is one example of a second opening/closing part.

The first painting robot 300A is attached to the wall surface of the painting area PA through the mover 430. The mover 430 is attached to the wall surface of the painting area PA and extends in the direction D1A. The mover 430 includes: a support base 431 that supports the first painting robot 300A; and a movement driver 432 that moves the support base 431. The mover 430 can move the support base 431 in the directions D1A and D1B together with the first painting robot 300A.

The first passive arm 100 is attached to the floor surface of the painting area PA through the mover 410. The mover 410 is attached to the floor surface of the painting area PA and extends in the direction D1A. The mover 410 is located under or below the mover 430. The mover 410 includes: a support base 411 that supports the first passive arm 100; and a movement driver 412 that moves the support base 411. The mover 410 can move the support base 411 in the directions D1A and D1B together with the first passive arm 100.

The second painting robot 300B is attached to the floor surface of the painting area PA through the mover 440. The mover 440 is attached to the floor surface of the painting area PA and extends in the direction D1A. The mover 440 includes: a support base 441 that supports the second painting robot 300B; and a movement driver 442 that moves the support base 441. The mover 440 can move the support base 441 in the directions D1A and D1B together with the second painting robot 300B.

The second passive arm 200 is attached to the wall surface of the painting area PA through the mover 420. The mover 420 is attached to the wall surface of the painting area PA and extends in the direction D1A. The mover 420 is located in the direction D2B with respect to the mover 440 and is opposed to the mover 440. The mover 420 includes: a support base 421 that supports the second passive arm 200; and a movement driver 422 that moves the support base 421. The mover 420 can move the support base 421 in the directions D1A and D1B together with the second passive arm 200.

The configurations of the movers 410 to 440 are not especially limited and may be, for example, known configurations. Although not limited to the followings, in the present embodiment, each of the movers 410 to 440 is a track type mover that moves the support base 411, 421, 431, or 441 on two tracks extending in the direction D1A. Each of the movement drivers 412 to 442 uses electric power as a power source and includes a servomotor as an electric motor. For example, each of the movement drivers 412 to 442 may include a rotating element that is rotated by the servomotor and rotates to move the support base 411, 421, 431, or 441. For example, the rotating element may be: a roller or gear that travels on the tracks together with the support base 411, 421, 431, or 441; a roller that drives a chain or belt connected to the support base 411, 421, 431, or 441; a ball screw connected to the support base 411, 421, 431, or 441; or the like.

The first controller 500A controls the operations of the first painting robot 300A, the first passive arm 100, the movers 410 and 430, and the like. Although not limited to the followings, in the present embodiment, the first controller 500A controls a combination of the first painting robot 300A and the first passive arm 100 and also controls the movers 410 and 430. The first controllers 500A are provided for the respective combinations. The second controller 500B controls the operations the second painting robot 300B, the second passive arm 200, the movers 420 and 440, and the like. Although not limited to the followings, in the present embodiment, the second controller 500B controls a combination of the second painting robot 300B and the second passive arm 200 and also controls the movers 420 and 440. The third controller 500C performs such control that the first controller 500A, the second controller 500B, and a controller CPL of the painting line apparatus PL operate in cooperation.

Configuration of Painting Robot

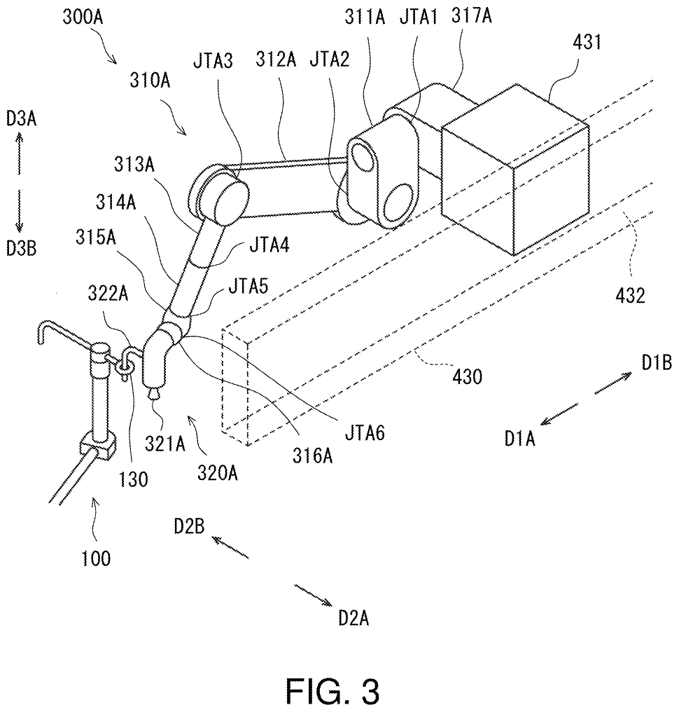

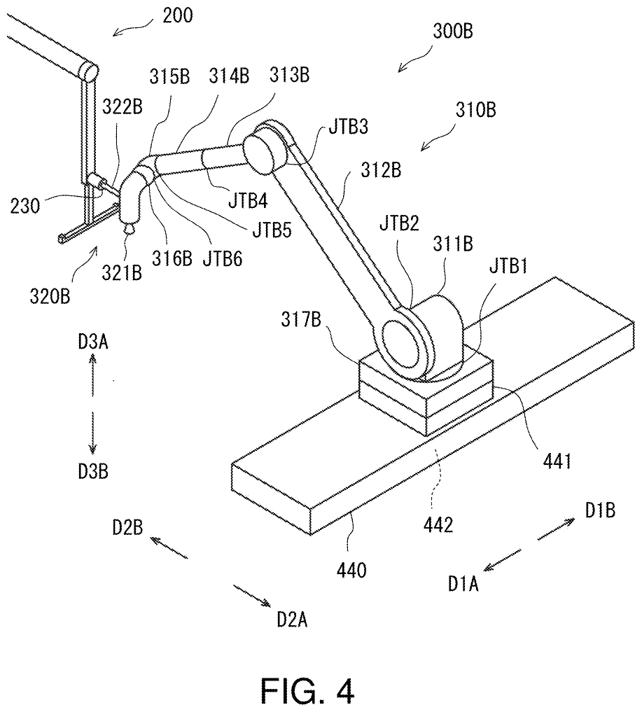

One example of the configurations of the painting robots 300A and 300B will be described with reference to FIGS. 3 and 4. FIG. 3 is a perspective view showing one example of the configuration of the first painting robot 300A according to the embodiment. FIG. 4 is a perspective view showing one example of the configuration of the second painting robot 300B according to the embodiment. The first painting robot 300A includes a robotic arm 310A and an end effector 320A attached to a tip of the robotic arm 310A. The second painting robot 300B includes a robotic arm 310B and an end effector 320B attached to a tip of the robotic arm 310B.

The robotic arm 310A can freely move the position and posture of the end effector 320A, and the robotic arm 310B can freely move the position and posture of the end effector 320B. Each of the robotic arms 310A and 310B is an active arm that can drive by itself. Each of the end effectors 320A and 320B has a structure that can apply an action to the target object. In the present embodiment, each of the end effectors 320A and 320B can spray a coating material to the target object.

Although not limited to the followings, in the present embodiment, each of the robotic arms 310A and 310B is a six-axis vertical articulated arm having six degrees of freedom. In the present embodiment, the configurations of the robotic arms 310A and 310B are different from each other but may be the same as each other.

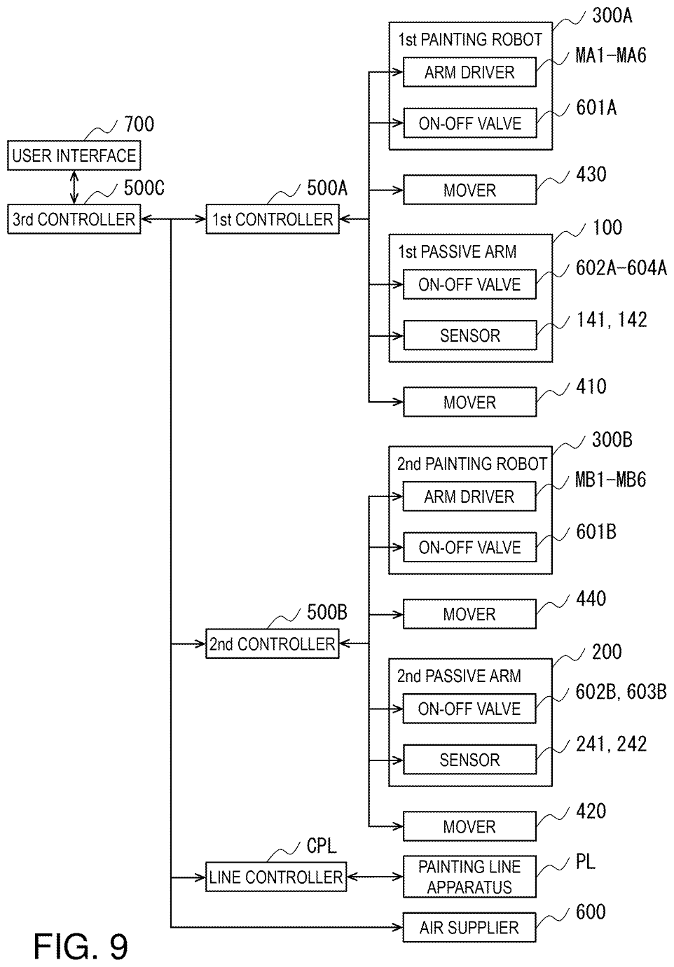

The robotic arm 310A includes a base 317A, six links 311A to 316A, six rotary joints JTA1 to JTA6, and arm drivers MA1 to MA6. The base 317A is fixed to the support base 431 of the mover 430. The rotary joints JTA1 to JTA6 connect the base 317A and the links 311A to 316A such that the base 317A and the links 311A to 316A are rotatable relative to each other. A tip portion of the link 316A includes a mechanical interface and is connectable to the end effector 320A. The arm drivers MA1 to MA6 respectively rotate the rotary joints JTA1 to JTA6. Each of the arm drivers MA1 to MA6 uses electric power as a power source. In the present embodiment, each of the arm drivers MA1 to MA6 includes a servomotor as an electric motor. The arm drivers MA1 to MA6 are shown in FIG. 9.

The robotic arm 310B includes a base 317B, six links 311B to 316B, six rotary joints JTB1 to JTB6, and arm drivers MB1 to MB6. The base 317B is fixed to the support base 441 of the mover 440. The rotary joints JTB1 to JTB connect the base 317B and the links 311B to 316B such that the base 317B and the links 311B to 316B are rotatable relative to each other. A tip portion of the link 316B includes a mechanical interface and is connectable to the end effector 320B. The arm drivers MB1 to MB6 respectively rotate the rotary joints JTB1 to JTB6. Each of the arm drivers MB1 to MB6 uses electric power as a power source. In the present embodiment, each of the arm drivers MB1 to MB6 includes a servomotor as an electric motor. The arm drivers MB1 to MB6 are shown in FIG. 9.

The end effector 320A includes a painting gun 321A that can eject the coating material, and the end effector 320B includes a painting gun 321B that can eject the coating material. The painting gun 321A is connected to piping extending along the robotic arm 310A, and the piping is connected to a coating material tank and an air supplier 600. The painting gun 321B is connected to piping extending along the robotic arm 310B, and the piping is connected to the coating material tank and the air supplier 600. The air supplier 600 is a device that can generate pressurized air. For example, the air supplier 600 may be an air compressor that compresses air and discharge the air. The air supplier 600 is shown in FIG. 9.

An on-off valve 601A is located on the piping through which the painting gun 321A and the air supplier 600 communicate with each other. The on-off valve 601A permits and blocks the flow in the piping. In the present embodiment, the on-off valve 601A is located at the end effector 320A but may be located at another place. An on-off valve 601B is located on the piping through which the painting gun 321B and the air supplier 600 communicate with each other. The on-off valve 601B permits and blocks the flow in the piping. In the present embodiment, the on-off valve 601B is located at the end effector 320B but may be located at another place. The on-off valves 601A and 601B are shown in FIG. 9 and may be, for example, electromagnetic valves. The operation of the on-off valve 601A is controlled by the first controller 500A, and the operation of the on-off valve 601B is controlled by the second controller 500B. The coating material in the coating material tank is supplied to the painting guns 321A and 321B and ejected from the painting guns 321A and 321B by the pressurized air generated by the air supplier 600. The coating material tank and the air supplier 600 are located separately from the robotic arms 310A and 310B.

The end effector 320A further includes a robot coupling 322A, and the end effector 320B further includes a robot coupling 322B. The robot coupling 322A can be coupled to a tip portion of the first passive arm 100. Although not limited to the followings, in the present embodiment, the robot coupling 322A is bent rod-shaped. The robot coupling 322A extends so as to project from the end effector 320A toward a lateral side, is bent, and extends along an opening direction of an ejection hole of the painting gun 321A.

The robot coupling 322B can be coupled to a tip portion of the second passive arm 200. Although not limited to the followings, in the present embodiment, the robot coupling 322B is rod-shaped and extends so as to project from the end effector 320B toward a lateral side.

The configurations of the painting robots 300A and 300B are not limited to the above configurations. For example, each of the number of joints of the robotic arm 310A and the number of joints of the robotic arm 310B is not limited to six and may be five or less or seven or more. Each of the types of the robotic arms 310A and 310B is not limited to a vertical articulated type and may be another type. The robotic arm 310A may couple the robot coupling 322A to the tip portion of the passive arm 100 and operate the passive arm 100, and the robotic arm 310B may couple the robot coupling 322B to the tip portion of the passive arm 200 and operate the passive arm 200.

Configuration of First Passive Arm

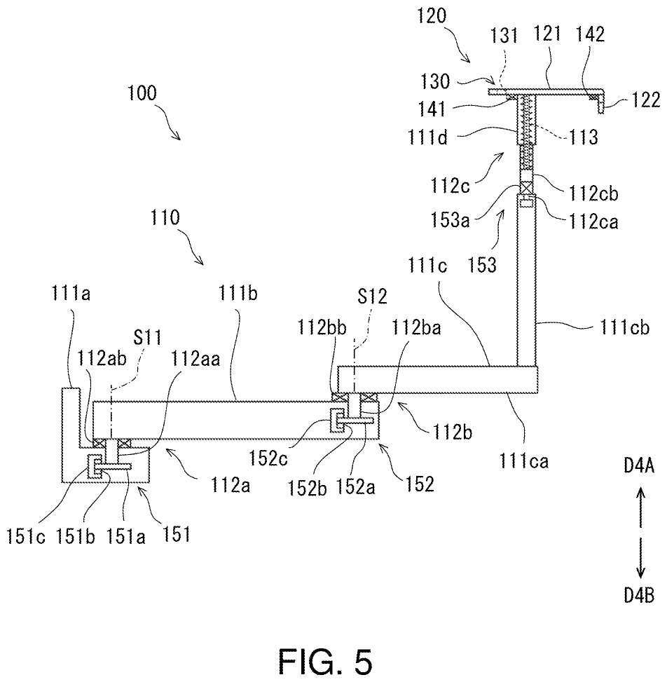

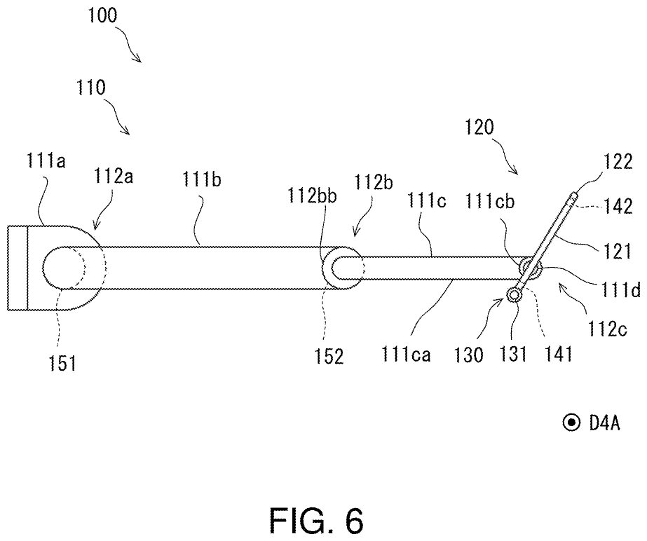

One example of the configuration of the first passive arm 100 will be described with reference to FIGS. 5 and 6. FIG. 5 is a side view showing one example of the configuration of the first passive arm 100, and FIG. 6 is a top view showing one example of the configuration of the first passive arm 100. In FIGS. 5 and 6, for convenience of the drawings, components located inside structures are also shown by solid lines.

The first passive arm 100 includes an arm body 110 and an end effector 120 coupled to a tip of the arm body 110. The arm body 110 can operate with two or more degrees of freedom. In the present embodiment, the arm body 110 can operate with three degrees of freedom. The end effector 120 has a structure that can apply an action to the target object. The end effector 120 is one example of an engaging structure.

The arm body 110 includes four links 111a to 111d and three passive movable structures 112a to 112c. The link 111a is one example of a base portion of the arm body 110 and is fixed to the support base 411 of the mover 410. Each of the links 111b to 111d has a columnar shape. In the arm body 110, the number of links may be three or less or five or more, and the number of passive movable structures may be two or less or four or more.

The passive movable structure 112a connects the link 111a and a base end of the link 111b such that the link 111a and the base end of the link 111b are turnable relative to each other. The passive movable structure 112a includes a turning shaft 112aa and a bearing 112ab. The turning shaft 112aa is connected to the base end of the link 111b so as to rotate integrally with the base end of the link 111b. The bearing 112ab is fixed to the link 111a and supports the turning shaft 112aa such that the turning shaft 112aa is rotatable. The link 111b is turnable about a shaft center S11 of the turning shaft 112aa. Although not limited to the followings, in the present embodiment, the link 111b extends in a direction perpendicular to the shaft center S11. The passive movable structure 112a can serve as a rotary joint. The passive movable structure 112a is one example of a first turning movable structure.

The terms “perpendicular,” “vertical,” “horizontal,” and “parallel” used in the present specification and the claims may denote the respective terms “completely perpendicular,” “completely vertical,” “completely horizontal,” and “completely parallel,” and may also denote the respective terms “substantially perpendicular,” “substantially vertical,” “substantially horizontal,” and “substantially parallel” which are close to the respective terms “completely perpendicular,” “completely vertical,” “completely horizontal,” and “completely parallel.”

The passive movable structure 112b connects a tip of the link 111b and a base end of the link 111c such that the tip of the link 111b and the base end of the link 111c are turnable relative to each other. The link 111b couples the passive movable structure 112a and the passive movable structure 112b. The passive movable structure 112b includes a turning shaft 112ba and a bearing 112bb. The turning shaft 112ba is connected to the base end of the link 111c so as to rotate integrally with the base end of the link 111c. The bearing 112bb is fixed to the link 111b and supports the turning shaft 112ba such that the turning shaft 112ba is rotatable. The link 111c is turnable about a shaft center S12 of the turning shaft 12ba. Although not limited to the followings, in the present embodiment, the link 111c extends in a direction perpendicular to the shaft center S12. The shaft center S12 extends in a direction similar to the direction of the shaft center S11, and for example, extends in parallel with the shaft center S11. The passive movable structure 112b can serve as a rotary joint. The passive movable structure 112b is one example of a second turning movable structure.

The link 111c includes a first portion 111ca and a second portion 111cb. The first portion 111ca extends from the turning shaft 112ba in a direction perpendicular to the shaft center S12, and the second portion 111cb extends from a tip of the first portion 111ca. The second portion 111cb extends in a direction D4A away from the first portion 111ca. Although not limited to the followings, in the present embodiment, the second portion 111cb extends in parallel with the shaft center S12 and has a cylindrical shape. Therefore, the shaft center S12 extends in the direction D4A.

The passive movable structure 112c connects a tip of the second portion 111cb of the link 111c and the link 111d such that the tip of the second portion 111cb of the link 111c and the link 111d can advance and retreat relative to each other. The link 111c couples the passive movable structure 112b and the passive movable structure 112c. The passive movable structure 112c is one example of an advance/retreat movable structure.

The link 111d is located at the second portion 111cb so as to be slidable along the second portion 111cb. The link 111d is slidable in the direction D4A and a direction D4B. The direction D4B is an opposite direction of the direction D4A. For example, the link 111d has a cylindrical shape, and the tip of the second portion 111cb is inserted into a base end of the link 111d. The base end of the link 111d forms a free end, and a tip of the link 111d is connected to the end effector 120.

The passive movable structure 112c includes a shaft 112ca and a locking structure 112cb. The locking structure 112cb is located inside the second portion 111cb. The shaft 112ca extends inside the link 111d and the second portion 111cb and penetrates the locking structure 112cb. One end of the shaft 112ca is connected to the tip of the link 111d or the end effector 120. The other end of the shaft 112ca is enlarged to form an enlarged end.

The shaft 112ca is slidable relative to the second portion 111cb in the directions D4A and D4B together with the link 111d. For example, the shaft 112ca and the link 111d can move in the direction D4B until the tip of the link 111d or the end effector 120 is brought into contact with the tip of the second portion 111cb. The shaft 112ca and the link 111d can move in the direction D4A until the enlarged end of the shaft 112ca is brought into contact with the locking structure 112cb. The locking structure 112cb can prevent the shaft 112ca from coming out from the second portion 111cb.

The arm body 110 further includes a biasing structure 113. The biasing structure 113 biases the link 111d in a direction away from the locking structure 112cb, specifically in the direction D4A. With this, when the link 111d does not receive external force acting in the direction D4B, the link 111d and the second portion 111cb can maintain an extended state in the direction D4A. For example, in the above state, the biasing structure 113 may have biasing force by which the enlarged end of the shaft 112ca is brought into contact with the locking structure 112cb. Although not limited to the followings, in the present embodiment, the biasing structure 113 is a coil spring. The biasing structure 113 is located between the tip of the link 111d and the locking structure 112cb or between the end effector 120 and the locking structure 112cb and is wound around the shaft 112ca.

Although not limited to the followings, in the present embodiment, the end effector 120 is connected to the tip of the link 111d so as not to move relative to the link 111d. The end effector 120 is rod-shaped. The end effector 120 includes an extension 121 and a projection 122. The extension 121 extends in a direction intersecting with the directions D4A and D4B, for example, in a direction perpendicular to the directions D4A and D4B. The projection 122 projects in the direction D4B from one end of the extension 121. The projection 122 can engage with a gap VDa located at an upper portion of the door VD of the vehicle body VB. Specifically, the projection 122 can be inserted into the gap VDa. The gap VDa is shown in FIG. 1. The gap VDa is a gap which is located between an exterior panel and interior panel of the door VD and to and from which a window can get in and out. The gap VDa is one example of a recess of the target object.

The end effector 120 integrally includes an arm coupling 130. The arm coupling 130 is located at another end portion of the extension 121. The arm coupling 130 includes an engagement hole 131 that penetrates the arm coupling 130 in the directions D4A and D4B. The engagement hole 131 is a hole into which the robot coupling 322A of the first painting robot 300A can be inserted. The arm coupling 130 is one example of the engaging structure.

The first passive arm 100 is located such that the directions D4A and D4B respectively extend along the directions D3A and D3B. The first passive arm 100 can move the end effector 120 by three degrees of freedom including: two degrees of freedom for turning in the horizontal direction; and one degree of freedom for advancing and retreating in the vertical direction. The robotic arm 310A of the first painting robot 300A can insert the robot coupling 322A into the engagement hole 131 from above.

The first passive arm 100 includes sensors 141 and 142. The first sensor 141 is located at the arm coupling 130 and detects the presence or absence of the robot coupling 322A in the engagement hole 131. The second sensor 142 is located at the projection 122 of the end effector 120 and detects the presence or absence of an object existing in the direction D4B that is a projecting direction of the projection 122. The second sensor 142 may be able to detect a distance from the second sensor 142 to an object in a detection target range. The sensors 141 and 142 output detection results to the first controller 500A. The first sensor 141 may be located at the robot coupling 322A or located at both of the arm coupling 130 and the robot coupling 322A.

The configurations of the sensors 141 and 142 are not especially limited, and the sensors 141 and 142 may have the above functions. For example, each of the sensors 141 and 142 may perform a detecting operation by using physical contact, light wave, laser, magnetism, radio wave, electromagnetic wave, ultrasound, a combination of two or more of these, or the like. Examples of the first sensor 141 include a contact sensor, a proximity sensor, a photoelectronic sensor, a laser sensor, a radio wave sensor, an electromagnetic wave sensor, an ultrasonic sensor, and a combination of two or more of these. Examples of the second sensor 142 include a photoelectronic sensor, a laser sensor, a radio wave sensor, an electromagnetic wave sensor, an ultrasonic sensor, various lidars (LiDAR), and a combination of two or more of these.

The first passive arm 100 includes locks 151 to 153 that can respectively lock the operations of the passive movable structures 112a to 112c. The lock 151 locks the turning operation of the passive movable structure 112a. The lock 152 locks the turning operation of the passive movable structure 112b. The lock 153 locks the advancing/retreating operation of the passive movable structure 112c. Although not limited to the followings, in the present embodiment, the locks 151 to 153 lock the operations by using frictional force. Each of the locks 151 to 153 may lock the operations by using another method, such as engaging or fitting.

In the present embodiment, each of the locks 151 and 152 has a similar configuration to disc brake system for a wheel. The lock 151 includes: a disc 151a integrally connected to the turning shaft 112aa; a friction material 151b; and a lock driver 151c that operates to press the friction material 151b against the disc 151a. The disc 151a rotates integrally with the turning shaft 112aa to which the disc 151a is connected. Similarly, the lock 152 includes: a disc 152a integrally connected to the turning shaft 112ba; a friction material 152b; and a lock driver 152c. For example, the lock driver 151c may include a piston that pushes the friction material 151b, and the lock driver 152c may include a piston that pushes the friction material 152b. The lock 151 is located inside the link 111a, and the lock 152 is located inside the link 111b.

The lock 153 includes a holder 153a that can operate to hold, such as grasp or clamp, an outer peripheral surface of the shaft 112ca. For example, as with the lock drivers 151c and 152c, the holder 153a may have a structure that can press a friction material against the shaft 112ca. The lock 153 is located inside the second portion 111cb of the link 111c. Specifically, the lock 153 is located between the locking structure 112cb and the enlarged end of the shaft 112ca.

Although not limited to the followings, in the present embodiment, each of the lock drivers 151c and 152c and the holder 153a is supplied with an operating fluid and executes or releases locking by the supply or supply stop of the operating fluid. In the present embodiment, the operating fluid is pressurized air supplied by the air supplier 600 but may be a liquid such as operating oil. The lock driver 151c is connected to the air supplier 600 through the piping and an on-off valve 602A. The lock driver 152c is connected to the air supplier 600 through the piping and an on-off valve 603A. The holder 153a is connected to the air supplier 600 through the piping and an on-off valve 604A. Each of the on-off valves 602A, 603A, and 604A operates electrically and can permit and block the flow in the piping. The on-off valves 602A, 603A, and 604A are shown in FIG. 9 and may be, for example, electromagnetic valves. In the present embodiment, the on-off valves 602A, 603A, and 604A are located at the first passive arm 100 but may be located outside the first passive arm 100. The operations of the on-off valves 602A, 603A, and 604A are controlled by the first controller 500A. When each of the on-off valves 602A, 603A, and 604A is in an open state, each of the lock drivers 151c and 152c and the holder 153a is supplied with the pressurized air. When each of the on-off valves 602A, 603A, and 604A is in a closed state, each of the lock drivers 151c and 152c and the holder 153a is not supplied with the pressurized air.

For example, each of the lock driver 151c and 152c includes a biasing structure such as a spring. The lock driver 151c presses the friction material 151b against the disc 151a by the biasing force of the biasing structure, and separates the friction material 151b from the disc 151a by the supplied pressurized air. The lock driver 152c presses the friction material 152b against the disc 152a by the biasing force of the biasing structure, and separates the friction material 152b from the disc 152a by the supplied pressurized air. When the on-off valve 602A is in a closed state, the lock driver 151c executes the locking. When the on-off valve 602A is in an open state, the lock driver 151c releases the locking. When the on-off valve 603A is in a closed state, the lock driver 152c executes the locking. When the on-off valve 603A is in an open state, the lock driver 152c releases the locking. A relation between the locking and locking release of the lock driver 151c and the closed state and open state of the on-off valve 602A may be reversed, and a relation between the locking and locking release of the lock driver 152c and the closed state and open state of the on-off valve 603A may be reversed.

For example, the holder 153a includes a biasing structure such as a spring, holds the outer peripheral surface of the shaft 112ca by the biasing force of the biasing structure, and releases the holding of the shaft 112ca by the supplied pressurized air. When the on-off valve 604A is in a closed state, the holder 153a executes the locking by the holding. When the on-off valve 604A is in an open state, the holder 153a releases the locking by the holding. A relation between the locking and locking release by the holding of the holder 153a and the closed state and open state of the on-off valve 604A may be reversed.

Configuration of Second Passive Arm

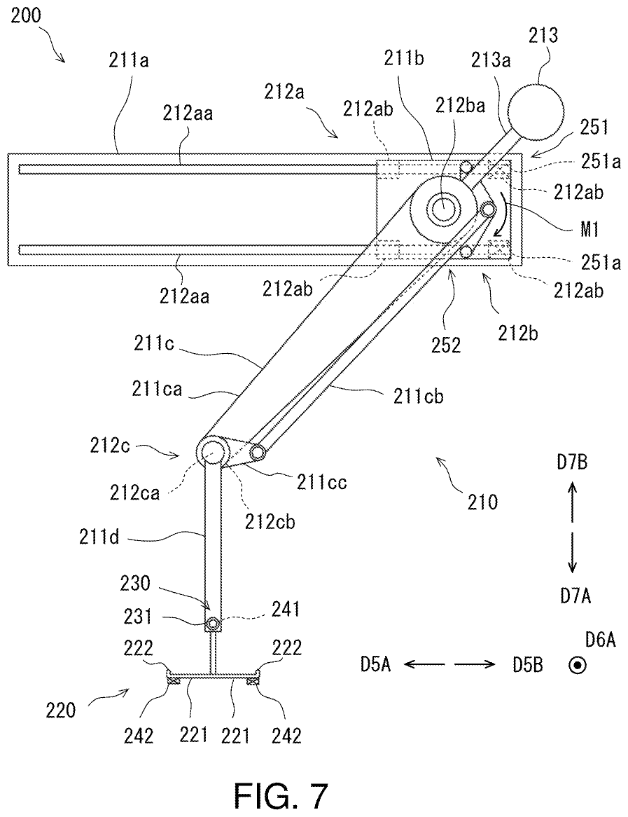

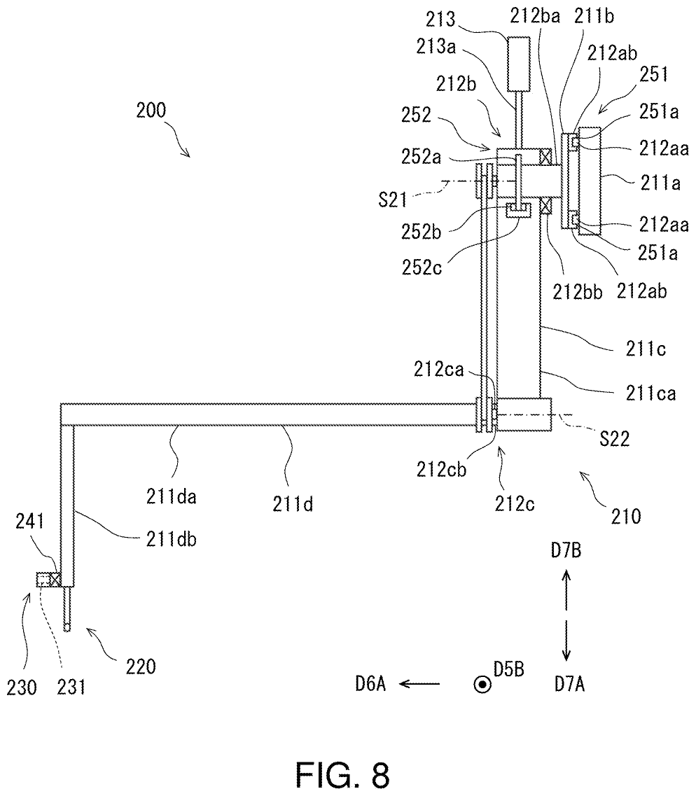

One example of the configuration of the second passive arm 200 will be described with reference to FIGS. 7 and 8. FIG. 7 is a front view showing one example of the configuration of the second passive arm 200, and FIG. 8 is a side view showing one example of the configuration of the second passive arm 200. In FIGS. 7 and 8, for convenience of the drawings, components located inside structures are also shown by solid lines.

The second passive arm 200 includes an arm body 210 and an end effector 220 coupled to a tip of the arm body 210. The arm body 210 can operate with two or more degrees of freedom. In the present embodiment, the arm body 210 can operate with three degrees of freedom. The end effector 220 has a structure that can apply an action to the target object. The end effector 220 is one example of the engaging structure.

The arm body 210 includes four links 211a to 211d, three passive movable structures 212a to 212c, and a load structure 213. The link 211a is one example of a base portion of the arm body 210 and is fixed to the support base 421 of the mover 420. The link 211a has a rectangular plate shape whose longitudinal direction is a direction D5A. In the arm body 210, the number of links may be three or less or five or more, and the number of passive movable structures may be two or less or four or more.

The passive movable structure 212a connects the link 211a and the link 211b such that the link 211a and the link 211b can advance and retreat relative to each other. The passive movable structure 212a is one example of the advance/retreat movable structure. The link 211b has a rectangular plate shape and is located so as to be opposed to the link 211a.

The passive movable structure 212a includes two guides 212aa and two or more engaging structures 212ab. The guides 212aa are located on a surface of the link 211a. Each of the guides 212aa projects from the surface of the link 211a and extends in the direction D5A in a ridge shape. The two guides 212aa extend in parallel with each other. The two guides 212aa form tracks that guide the movement of the link 211b. The two guides 212aa may be rails.

The two or more engaging structures 212ab are located at the link 211b and engage with the guides 212aa so as to be slidable. Each of the engaging structures 212ab is slidable along the guide 212aa while maintaining engagement with the guide 212aa such that the engaging structure 212ab does not derail from the guide 212aa. Although not limited to the followings, in the present embodiment, four engaging structures 212ab are located. Two engaging structures 212ab engage with one guide 212aa, and the remaining two engaging structures 212ab engage with the other guide 212aa. The link 211b is movable along the guides 212aa in the directions D5A and D5B. The direction D5B is an opposite direction of the direction D5A.

The passive movable structure 212b connects the link 211b and a base end of the link 211c such that the link 211b and the base end of the link 211c are turnable relative to each other. The link 211b couples the passive movable structure 212a and the passive movable structure 212b. The passive movable structure 212b includes a turning shaft 212ba and a bearing 212bb. The turning shaft 212ba is integrally connected to the link 211b. The bearing 212bb is fixed to the base end of the link 211c and supports the turning shaft 212ba such that the turning shaft 212ba is rotatable. The link 211c is turnable about a shaft center S21 of the turning shaft 212ba. Although not limited to the followings, in the present embodiment, the link 211c extends in a direction perpendicular to the shaft center S21. The shaft center S21 extends in a direction perpendicular to the directions D5A and D5B. The shaft center S21 extends in a direction intersecting with the links 211a and 211b, for example, in a direction perpendicular to the links 211a and 211b. The passive movable structure 212b can serve as a rotary joint. The passive movable structure 212b is one example of the turning movable structure.

The passive movable structure 212c connects a tip of the link 211c and a base end of the link 211d such that the tip of the link 211c and the base end of the link 211d are turnable relative to each other. The link 211c couples the passive movable structure 212b and the passive movable structure 212c. The passive movable structure 212c includes a turning shaft 212ca and a bearing 212cb. The turning shaft 212ca is integrally connected to the base end of the link 211d. The bearing 212cb is fixed to the tip of the link 211c and supports the turning shaft 212ca such that the turning shaft 212ca is rotatable. The link 211d is turnable about a shaft center S22 of the turning shaft 212ca. Although not limited to the followings, in the present embodiment, the shaft center S22 extends in a direction similar to the direction of the shaft center S21. For example, the shaft center S22 extends in parallel with the shaft center S21. The passive movable structure 212c is one example of the turning movable structure.

The link 211c includes the configuration of a parallel link. The link 211c includes a first member 211ca, a second member 211cb, and a third member 211cc. The first member 211ca, the second member 211cb, and the third member 211cc are columnar members.

The first member 211ca couples the passive movable structures 212b and 212c. Specifically, one end of the first member 211ca is connected to the link 211b by the passive movable structure 212b so as to be turnable, and another end of the first member 211ca is connected to the base end of the link 211d by the passive movable structure 212c so as to be turnable.

The second member 211cb extends along the first member 211ca, and one end of the second member 211cb is coupled to the link 211b so as to be turnable. Specifically, one end of the second member 211cb is connected to the link 211b at a position away from the first member 211ca. Another end of the second member 211cb is connected to one end of the third member 211cc so as to be turnable. The one end of the third member 211cc is coupled to the other end of the second member 211cb so as to be turnable, and another end of the third member 211cc is coupled to the passive movable structure 212c.

A distance between two connection portions of the first member 211ca is equal to a distance between two connection portions of the second member 211cb. A distance between a connection portion where the link 211b and the first member 211ca are connected and a connection portion where the link 211b and the second member 211cb are connected is equal to a distance between two connection portions of the third member 211cc. Therefore, when the first member 211ca turns, the third member 211cc is moved in parallel.

Although not limited to the followings, in the present embodiment, the other end of the third member 211cc is coupled to the base end of the link 211d so as to turn integrally with the link 211d. With this, when the first member 211ca turns, the link 211d is moved in parallel together with the third member 211cc. Therefore, the posture of the link 211d is maintained.

The link 211d has a columnar shape. The link 211d includes a first portion 211da and a second portion 211db. The first portion 211da extends from the passive movable structure 212c in a direction D6A along the shaft center S22. The second portion 211db extends from a tip of the first portion 211da. The second portion 211db extends in a direction D7A away from the first portion 211da. Although not limited to the followings, in the present embodiment, the first portion 211da extends in parallel with the shaft center S22, and the direction D6A is a direction perpendicular to the directions D5A and D5B and away from the links 211a and 211b. The second portion 211db extends perpendicular to the first portion 211da, and the direction D7A is a direction perpendicular to the direction D6A and away from the links 211a and 211b. A tip of the link 211d is connected to the end effector 220.

Although not limited to the followings, in the present embodiment, the end effector 220 is connected to the link 211d so as not to move relative to the link 211d. The end effector 220 is rod-shaped. The end effector 220 includes an extension 221 and projections 222. The extension 221 extends in a direction intersecting with the direction D7A, for example, in a direction perpendicular to the direction D7A. Both ends of the extension 221 project in the directions D5A and D5B beyond the link 211d. The projections 222 project from both ends of the extension 221 in a direction D7B. The direction D7B is an opposite direction of the direction D7A. The projection 222 can engage with an opening of a holding tool Va attached to the front hood VF of the vehicle body VB or the rear gate VG of the vehicle body VB. Specifically, the projection 222 can be inserted into the opening. The holding tool Va is shown in FIG. 2. The holding tool Va is a metal fitting held when opening or closing the front hood VF or the rear gate VG.

An arm coupling 230 is integrally located at the tip of the link 211d. The arm coupling 230 includes an engagement hole 231 that is open in the direction D6A. The engagement hole 231 is a hole into which the robot coupling 322B of the second painting robot 300B can be inserted. The arm coupling 230 is one example of the engaging structure.

The load structure 213 is an object having predetermined mass or more. The load structure 213 is coupled to the link 211c so as to move integrally with the link 211c. The load structure 213 is located at an opposite side of the link 211c across the passive movable structure 212b. The load structure 213 is integrally coupled to the first member 211ca by a coupling member 213a. The coupling member 213a positions the load structure 213 such that the load structure 213 is located away from the first member 211ca and the passive movable structure 212b. The load structure 213 may generate, at the first member 211ca, a downward rotational moment M1 about the passive movable structure 212b. The load structure 213 is not limited to the above object and may be able to apply a rotational moment to the first member 211ca. For example, the load structure 213 may be a biasing structure, such as a spiral spring, which applies the rotational moment M1 to the first member 211ca.

The second passive arm 200 is located such that: the directions D5A and D5B respectively extend along the directions D1A and D1B; the direction D6A extends along the direction D2A; and the directions D7A and D7B respectively extend along the directions D3B and D3A. The second passive arm 200 can move the end effector 220 by three degrees of freedom including: two degrees of freedom for turning in the vertical direction, and one degree of freedom for advancing and retreating in the horizontal direction. The robotic arm 310B of the painting robot 300B can insert the robot coupling 322B into the engagement hole 231 from a lateral side.

The second passive arm 200 includes: a first sensor 241 similar to the first sensor 141 of the first passive arm 100; and a second sensor 242 similar to the second sensor 142 of the first passive arm 100. The first sensor 241 is located at the arm coupling 230. The second sensor 242 is located at one of the projections 222 of the end effector 220 or located at both of the projections 222 of the end effector 220. The sensors 241 and 242 output detection results to the second controller 500B. The first sensor 241 may be located at the robot coupling 322B or located at both of the arm coupling 230 and the robot coupling 322B.

The second passive arm 200 includes locks 251 and 252 that can respectively lock the operations of the passive movable structures 212a and 212b. Although not limited to the followings, in the present embodiment, the locks 251 and 252 lock the operations by using frictional force. The lock 251 locks the advancing/retreating operation of the passive movable structure 212a. The lock 252 has a similar configuration to the locks 151 and 152 of the first passive arm 100 and locks the turning operation of the passive movable structure 212b.

The lock 252 is located inside the first member 211ca. The lock 252 includes: a disc 252a integrally attached to the turning shaft 212ba; a friction material 252b; and a lock driver 252c.

The lock 251 is located at the engaging structures 212ab of the link 211b. Specifically, the lock 251 is located at the engaging structures 212ab of the two guides 212aa. The lock 251 includes holders 251a that grasp outer surfaces of the guides 212aa. Each of the holders 251a may have a similar configuration to the holder 153a of the first passive arm 100.

Each of the holders 251a and the lock driver 252c executes or releases locking by the supply or supply stop of the pressurized air supplied by the air supplier 600. The holders 251a are connected to the air supplier 600 through the piping and an on-off valve 602B. The lock driver 252c is connected to the air supplier 600 through the piping and an on-off valve 603B. The on-off valves 602B and 603B operate electrically, and the operations of the on-off valves 602B and 603B are controlled by the second controller 500B. The on-off valves 602B and 603B are shown in FIG. 9 and may be, for example, electromagnetic valves. In the present embodiment, the on-off valves 602B and 603B are located at the second passive arm 200 but may be located outside the second passive arm 200. When the pressurized air is supplied, each of the holders 251a and the lock driver 252c releases the locking. When the supply of the pressurized air stops, each of the holders 251a and the lock driver 252c executes the locking. A relation between the locking and locking release of each of the holders 251a and the lock driver 252c and the supply and supply stop of the pressurized air may be reversed.

Configuration of Controller

One example of the configurations of the controllers 500A to 500C and their peripheries according to the embodiment will be described with reference to FIG. 9. FIG. 9 is a block diagram showing one example of the configurations of the controllers 500A to 500C and their peripheries according to the embodiment.

The third controller 500C is connected to the first controller 500A, the second controller 500B, the line controller CPL of the painting line apparatus PL, and a user interface 700 through wired communication, wireless communication, or a combination thereof such that signal transmission and reception can be performed therebetween. The wired communication may be any wired communication, and the wireless communication may be any wireless communication.

The third controller 500C receives a command, information, data, and the like, which have been input to the user interface 700, from the user interface 700, and performs control in accordance with the command, the information, the data, and the like. The third controller 500C outputs various pieces of information, data, and the like of the robot system 1 to the user interface 700. The third controller 500C may receive, from the first controller 500A, the second controller 500B, and the line controller CPL, information indicating operating states of components of control targets of the first controller 500A, the second controller 500B, and the line controller CPL. Based on the information, the third controller 500C may transmit commands of operation timings of the components of the control targets to the first controller 500A, the second controller 500B, and the line controller CPL. The operation timing is a timing at which an operation is executed. The third controller 500C may be connected to the air supplier 600 and control the operation of the air supplier 600. The information which is transmitted from the line controller CPL and indicates the operating state of the painting line apparatus PL is one example of the information of the target object.

The third controller 500C may include a computer. The third controller 500C may transmit or receive signals to or from another controller and the like through, for example, I/O communication and may control the operation of another controller and the like based on the signals. In FIG. 9, the third controller 500C is connected to one first controller 500A and one second controller 500B. However, the number of first controllers 500A that are the control targets of the third controller 500C may be any value, and the number of second controllers 500B that are the control targets of the third controller 500C may be any value.

The first controller 500A controls the operations of the first painting robot 300A, the first passive arm 100, the movers 410 and 430, and the like in accordance with, for example, the commands of the operation timings received from the third controller 500C. For example, the first controller 500A may control the operations of the servomotors of the arm drivers MA1 to MA6, the on-off valves 601A to 604A, the sensors 141 and 142, and the servomotors of the movers 410 and 430. Although not limited to the followings, in the present embodiment, the first controller 500A controls the operations of the control targets by an autonomous operation based on a control program. The first controller 500A may include a computer and may further include drive circuitry of electric components, such as the servomotors.

The second controller 500B controls the operations of the second painting robot 300B, the second passive arm 200, the movers 420 and 440, and the like in accordance with, for example, the commands of the operation timings received from the third controller 500C. For example, the second controller 500B may control the operations of the servomotors of the arm drivers MB1 to MB6, the on-off valves 601B to 603B, the sensors 241 and 242, and the servomotors of the movers 420 and 440. Although not limited to the followings, in the present embodiment, the second controller 500B controls the operations of the control targets by the autonomous operation based on the control program. The second controller 500B may include a computer and may further include drive circuitry of electric components, such as the servomotors.

The controllers 500A and 500B may servo-control the servomotors. The controllers 500A and 500B may: acquire, from the servomotors, detection results of rotation sensors included in the servomotors; acquire supply current values supplied from the drive circuitry of the servomotors to the servomotors; and determine command values of currents supplied to the servomotors by using the detection results of the rotation sensors and the supply current values as feedback information. The supply current values may be command values of currents supplied from the drive circuitry to the servomotors or may be detection results of current sensors which may be located at the servomotors.

The line controller CPL controls the operation of the painting line apparatus PL. The line controller CPL may include a control panel, such as a Line Controller. The line controller is also called a “process control panel” or a “line control panel.”

The user interface 700 receives inputs, such as a command, information, and data, from a user, such as an operator, and outputs the inputs to the third controller 500C and the like. The user interface 700 receives information, data, and the like transmitted from the third controller 500C and the like and presents the information, the data, and the like to the user. The user interface 700 includes an inputter and a presenter, such as a display. The inputter may be any known inputter, and the presenter may be any known device that, for example, visually and aurally gives perceptible information to the user.

Examples of the controllers 500A to 500C may include an electronic circuit substrate, an electronic control unit, a microcomputer, a personal computer, a work station, a smart device such as a smartphone or a tablet, another electronic device, and the like. Each of the controllers 500A to 500C may include circuitry, and the circuitry may include a processor and a memory. The circuitry may include processing circuitry. The circuitry may include a CPU (Central Processing Unit) as the processor and include, as the memory, a nonvolatile semiconductor memory such as a ROM (Read Only Memory), a volatile semiconductor memory such as a RAM (Random Access Memory), and the like. For example, a program used to operate the CPU is prestored in the ROM or the like. The CPU reads the program from the ROM and expands the program in the RAM. The CPU executes coded commands in the program expanded in the RAM. In addition to the memory, each of the controllers 500A to 500C may include a storage. The storage may include a memory apparatus, such as a semiconductor memory, a hard disc drive (HDD), or a solid state drive (SSD).

Some or all of the functions of the controllers 500A to 500C may be realized by: a computer system including a processor, a memory, and the like; dedicated hardware circuitry, such as electronic circuitry or integrated circuitry; or a combination of the above computer system and the above hardware circuitry. Each of the controllers 500A to 500C may execute each processing by centralized control performed by a single device or may execute each processing by distributed control performed by devices in cooperation.

Although not limited to the followings, for example, the processor may include a CPU, a MPU (Micro Processing Unit), a GPU (Graphics Processing Unit), a microprocessor, a processor core, a multiprocessor, an ASIC (Application-Specific Integrated Circuit), a FPGA (Field Programmable Gate Array), or the like. The processor may realize each processing by logic circuitry or dedicated circuitry formed in an IC (integrated circuit) chip, a LSI (Large Scale Integration), or the like. Processings may be realized by one or more integrated circuits or may be realized by one integrated circuit.

Functional Configuration of Controller

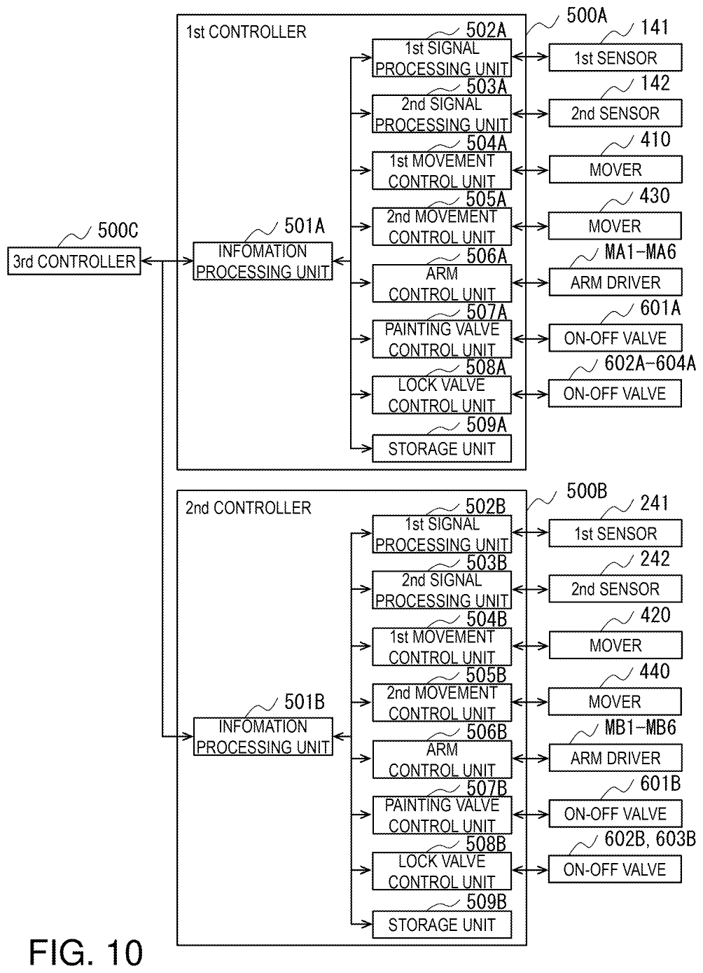

One example of functional configurations of the first controller 500A and the second controller 500B according to the embodiment will be described with reference to FIG. 10. FIG. 10 is a block diagram showing one example of the functional configurations of the first controller 500A and the second controller 500B according to the embodiment. The functional configuration of the first controller 500A and the functional configuration of the second controller 500B are similar to each other.

The first controller 500A includes, as functional components, an information processing unit 501A, a first signal processing unit 502A, a second signal processing unit 503A, a first movement control unit 504A, a second movement control unit 505A, an arm control unit 506A, a painting valve control unit 507A, a lock valve control unit 508A, and a storage unit 509A. The function of the storage unit 509A may be realized by the memory and the like. The functions of the functional components other than the storage unit 509A may be realized by the processor and the like. Not all the functional components are essential.

The storage unit 509A stores various pieces of information, data, and the like and enables readout of the stored information, data, and the like. For example, the storage unit 509A stores a control program, various pieces of data, and the like.

The information processing unit 501A processes the command, the information, the signal, and the like received from the third controller 500C and outputs the command, the information, the signal, and the like to the associated functional components in the first controller 500A. For example, the above command may include an operation timing or the like. The information processing unit 501A processes the information, the signal, and the like output from the functional components of the first controller 500A and transmits the information, the signal, and the like to the third controller 500C.

The first signal processing unit 502A receives the signals from the first sensor 141 and processes the signals. The first signal processing unit 502A detects based on the signals of the first sensor 141 whether or not the robot coupling 322A of the first painting robot 300A is in the engagement hole 131 of the arm coupling 130 of the first passive arm 100. Then, the first signal processing unit 502A outputs a detection result to the arm control unit 506A and the like.

The second signal processing unit 503A receives the signals from the second sensor 142 and processes the signals. The second signal processing unit 503A detects based on the signals of the second sensor 142 whether or not there exists an object in the projecting direction D4B from the projection 122 of the end effector 120 of the first passive arm 100. Then, the second signal processing unit 503A outputs a detection result to the arm control unit 506A and the like. For example, when the projection 122 is located right above the gap VDa of the door VD of the vehicle body VB and is directed to the gap VDa, the second sensor 142 does not detect an object. Therefore, the second signal processing unit 503A detects the nonexistence of the object, and with this, can detect the existence of the gap VDa. When the projection 122 is inserted into the gap VDa by a predetermined length or more, the second sensor 142 detects an inner surface of the exterior panel of the door VD. Therefore, the second signal processing unit 503A detects the existence of the object, and with this, can detect that the insertion of the projection 122 into the gap VDa has been completed.

The first movement control unit 504A controls the operation of the mover 410 in accordance with the control program and the command of the operation timing or the like from the third controller 500C. For example, the first movement control unit 504A calculates target values of the position, speed, and the like of the support base 411 of the mover 410 and outputs a command value by which the support base 411 is moved in accordance with the target values, to the movement driver 412. The command value may be a command value of a current supplied to the servomotor. For example, the first movement control unit 504A may cause the movement driver 412 to move the support base 411 such that the support base 411 moves in synch with the movement of the vehicle body VB moved by the painting line apparatus PL.

The second movement control unit 505A controls the operation of the mover 430 in accordance with the control program and the command of the operation timing or the like from the third controller 500C. For example, the second movement control unit 505A calculates the target values of the position, speed, and the like of the support base 431 of the mover 430 and outputs a command value by which the support base 431 is moved in accordance with the target values, to the movement driver 432. The command value may be a command value of a current supplied to the servomotor. For example, the second movement control unit 505A may cause the movement driver 432 to move the support base 431 such that the support base 431 moves in synch with the movement of the vehicle body VB moved by the painting line apparatus PL.

The arm control unit 506A controls the operation of the robotic arm 310A in accordance with the control program and the command of the operation timing or the like from the third controller 500C. For example, the arm control unit 506A calculates the target values of the position, posture, movement speed of the position, movement speed of the posture, and the like of the end effector 320A and outputs command values by which the end effector 320A is moved in accordance with the target values, to the arm drivers MA1 to MA6. The command values may be command values of currents supplied to the servomotors. Moreover, by using the detection results received from the signal processing units 502A and 503A, the arm control unit 506A controls the operation of the robotic arm 310A by which the end effector 320A is positioned.

The painting valve control unit 507A controls the operation of the on-off valve 601A in accordance with the control program. To be specific, the painting valve control unit 507A controls the ejection of the coating material from the painting gun 321A of the end effector 320A.

The lock valve control unit 508A controls the operations of the on-off valves 602A to 604A of the locks 151 to 153 of the first passive arm 100 in accordance with the control program. To be specific, the lock valve control unit 508A controls the locking operations of the locks 151 to 153. The lock valve control unit 508A may use, for the control, the detection results received from the signal processing units 502A and 503A.

As with the first controller 500A, the second controller 500B includes, as functional components, an information processing unit 501B, a first signal processing unit 502B, a second signal processing unit 503B, a first movement control unit 504B, a second movement control unit 505B, an arm control unit 506B, a painting valve control unit 507B, a lock valve control unit 508B, and a storage unit 509B. The function of the storage unit 509B may be realized by the memory and the like. The functions of the functional components other than the storage unit 509B may be realized by the processor and the like. The functions of the functional components of the second controller 500B are similar to those of the first controller 500A. Therefore, regarding the functional components of the second controller 500B, differences from the first controller 500A will be mainly described, and similarities are not described. Not all the functional components of the second controller 500B are essential.

The first signal processing unit 502B processes the signals received from the first sensor 241 and outputs a processing result to the arm control unit 506B or the like. The first signal processing unit 502B detects based on the signals whether or not the robot coupling 322B of the second painting robot 300B is in the engagement hole 231 of the arm coupling 230 of the second passive arm 200.

The second signal processing unit 503B processes the signals received from the second sensor 242 and outputs a processing result to the arm control unit 506B or the like. For example, the second signal processing unit 503B can detect that the projection 222 of the end effector 220 of the second passive arm 200 is located right under the opening of the holding tool Va of the front hood VF or the rear gate VG of the vehicle body VB and is directed to the opening.

The first movement control unit 504B controls the operation of the mover 420 in accordance with the control program and the command from the third controller 500C.

The second movement control unit 505B controls the operation of the mover 440 in accordance with the control program and the command from the third controller 500C.

The arm control unit 506B controls the operation of the robotic arm 310B in accordance with the control program and the command from the third controller 500C. Moreover, by using the detection results received from the signal processing units 502B and 503B, the arm control unit 506B controls the operation of the robotic arm 310B by which the end effector 320B is positioned.

The painting valve control unit 507B controls the operation of the on-off valve 601B in accordance with the control program and controls the ejection of the coating material from the painting gun 321B of the end effector 320B.

The lock valve control unit 508B controls the operations of the on-off valves 602B and 603B of the locks 251 and 252 of the second passive arm 200 and the locking operations of the locks 251 and 253 in accordance with the control program. The lock valve control unit 508B may use, for the control, the detection results received from the signal processing units 502B and 503B.

Operation of Robot System

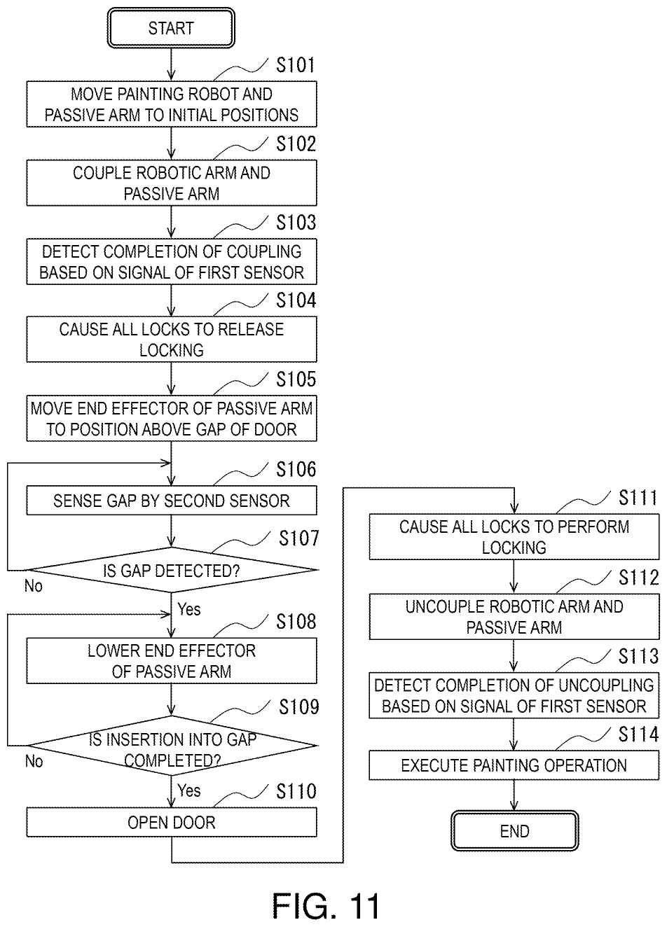

Examples of the operation of the robot system 1 according to the embodiment will be described. First, one example of the operation of the robot system 1 when opening the door VD of the vehicle body VB by using the first painting robot 300A and the first passive arm 100 will be described with reference to FIGS. 1 and 11. FIG. 11 is a flowchart showing one example of an opening operation of the robot system 1 according to the embodiment.

In Step S101, the first controller 500A causes the mover 410 to move the first passive arm 100 to an initial position for the opening operation and causes the mover 430 to move the first painting robot 300A to an initial position for the opening operation. For example, the initial positions may be positions preset for the vehicle body VB. The initial positions may be such positions that the first painting robot 300A can insert the robot coupling 322A into the engagement hole 131 of the arm coupling 130 of the first passive arm 100. The first passive arm 100 is kept in an initial state in advance. In the initial state, the arm body 110 is held in a predetermined posture with respect to the support base 411 of the mover 410, and the end effector 120 is held at a predetermined position in a predetermined posture with respect to the support base 411. The air supplier 600 is in an operating state, and the locks 151 to 153 are in a lock state.

Next, in Step S102, the first controller 500A operates the robotic arm 310A of the first painting robot 300A to insert the robot coupling 322A into the engagement hole 131 and couple the robot coupling 322A to the arm coupling 130. To be specific, the first controller 500A couples the robotic arm 310A and the first passive arm 100.

Next, in Step S103, based on the signals of the first sensor 141, the first controller 500A detects the completion of the insertion of the robot coupling 322A into the engagement hole 131, i.e., the completion of the coupling.

Next, in Step S104, the first controller 500A switches the on-off valves 602A to 604A from a closed state to an open state and causes all the locks 151 to 153 to release the locking.

Next, in Step S105, the first controller 500A operates the robotic arm 310A to move the end effector 120 of the first passive arm 100 to a position above the gap VDa of the closed-state door VD of the vehicle body VB.

Next, in Step S106, the first controller 500A causes the second sensor 142 to perform sensing and causes the robotic arm 310A to move the end effector 120 in the horizontal direction.

When the first controller 500A detects the gap VDa based on the signals of the second sensor 142 (Yes in Step S107), the first controller 500A proceeds to Step S108. When the first controller 500A does not detect the gap VDa (No in Step S107), the first controller 500A repeats Step S106. That the gap VDa is detected denotes that it is detected that the gap VDa is located in a downward projecting direction of the projection 122 of the end effector 120.

In Step S108, the first controller 500A causes the second sensor 142 to perform sensing and causes the robotic arm 310A to move the end effector 120 in the lower direction D3B and insert the projection 122 into the gap VDa.

When the first controller 500A detects the completion of the insertion of the projection 122 into the gap VDa based on the signals of the second sensor 142 (Yes in Step S109), the first controller 500A causes the robotic arm 310A to stop the movement of the end effector 120 in the lower direction D3B and proceeds to Step S110. When the first controller 500A does not detect the completion of the insertion (No in Step S109), the first controller 500A repeats Step S108. With this, the extension 121 of the end effector 120 is prevented from colliding with the door VD.

In Step S110, the first controller 500A causes the robotic arm 310A to move the end effector 120 in the horizontal direction to open the door VD of the vehicle body VB.

Next, in Step S111, when the first controller 500A opens the door VD of the vehicle body VB to a predetermined position, the first controller 500A switches the on-off valves 602A to 604A from the open state to the closed state and causes all the locks 151 to 153 to perform the locking. With this, the first passive arm 100 maintains the open state of the door VD.

Next, in Step S112, the first controller 500A operates the robotic arm 310A to pull out the robot coupling 322A from the engagement hole 131 to uncouple the robot coupling 322A and the engagement hole 131.

Next, in Step S113, based on the signals of the first sensor 141, the first controller 500A detects the completion of the pulling-out of the robot coupling 322A from the engagement hole 131, i.e., the completion of the uncoupling of the robot coupling 322A and the engagement hole 131.

Next, in Step S114, the first controller 500A switches the on-off valve 601A from the closed state to the open state and causes the robotic arm 310A to execute a painting operation. With this, the first painting robot 300A can perform the painting work of an inside of the vehicle body VB.

The second controller 500B performs processing similar to the above processing of the first controller 500A, and with this, can open the front hood VF and the rear gate VG of the vehicle body VB by using the second painting robot 300B and the second passive arm 200. In steps similar to Steps S105 to S108, the second controller 500B causes the robotic arm 310B to insert one of the projections 222 of the end effector 220 of the second passive arm 200 into the opening of the holding tool Va from below. A step similar to Step S109 may be omitted.

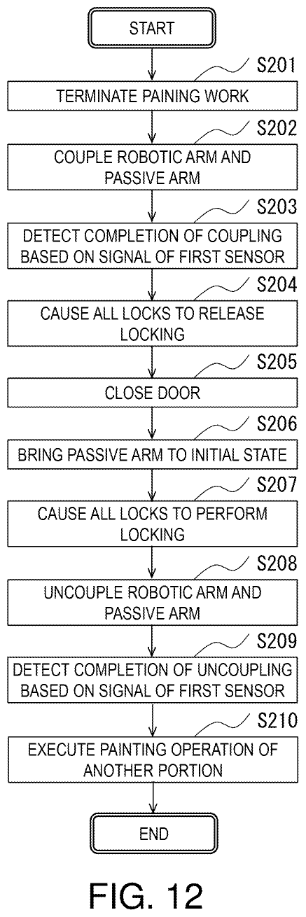

Next, one example of the operation of the robot system 1 when closing the door VD of the vehicle body VB by using the first painting robot 300A and the first passive arm 100 will be described with reference to FIGS. 1 and 12. FIG. 12 is a flowchart showing one example of a closing operation of the robot system 1 according to the embodiment.

In Step S201, when predetermined painting work of the first painting robot 300A is completed, the first controller 500A switches the on-off valve 601A from the open state to the closed state and terminates the painting work.

Next, in Step S202, the first controller 500A operates the robotic arm 310A of the first painting robot 300A to insert the robot coupling 322A into the engagement hole 131 of the arm coupling 130 of the first passive arm 100 and couple the robotic arm 310A and the first passive arm 100.

Next, in Step S203, based on the signals of the first sensor 141, the first controller 500A detects the completion of the insertion of the robot coupling 322A into the engagement hole 131, i.e., the completion of the coupling.

Next, in Step S204, the first controller 500A switches the on-off valves 602A to 604A switch from the closed state to the open state and causes all the locks 151 to 153 to release the locking.

Next, in Step S205, the first controller 500A causes the robotic arm 310A to move the end effector 120 in the horizontal direction to close the door VD of the vehicle body VB.

Next, in Step S206, the first controller 500A causes the robotic arm 310A to move the end effector 120 and bring the first passive arm 100 to an initial state. The initial state is the same as the initial state in Step S101 in the operation of opening the door VD. For example, the initial state may be such a state of the first passive arm 100 that the first passive arm 100 does not interfere with the vehicle body VB conveyed in the direction D1A and does not interfere with the painting robots 300A and 300B which perform another painting work.

Next, in Step S207, after the bringing of the first passive arm 100 to the initial state is completed, the first controller 500A switches the on-off valves 602A to 604A from the open state to the closed state and causes all the locks 151 to 153 to perform the locking. With this, initial state of the first passive arm 100 is maintained.

Next, in Step S208, the first controller 500A operates the robotic arm 310A to pull out the robot coupling 322A from the engagement hole 131 to uncouple the robot coupling 322A and the engagement hole 131.

Next, in Step S209, based on the signals of the first sensor 141, the first controller 500A detects the completion of the pulling-out of the robot coupling 322A from the engagement hole 131, i.e., the completion of the uncoupling of the robot coupling 322A and the engagement hole 131.

Next, in Step S210, the first controller 500A switches the on-off valve 601A from the closed state to the open state and causes the robotic arm 310A to perform the painting operation of another portion.

The second controller 500B performs processing similar to the above processing of the first controller 500A, and with this, can close the front hood VF and the rear gate VG of the vehicle body VB by using the second painting robot 300B and the second passive arm 200.

### Other Embodiments

The foregoing has described the example of the embodiment of the present disclosure. However, the present disclosure is not limited to the above embodiment. To be specific, various modifications and improvements may be made within the scope of the present disclosure. For example, embodiments prepared by variously modifying the embodiment and embodiments prepared by combining components in different embodiments are also included in the scope of the present disclosure.

For example, in the robot system 1 according to the embodiment, targets to be operated by using the painting robots 300A and 300B as the active robots and the passive arms 100 and 200 are the door VD, the front hood VF, and the rear gate VG of the vehicle body VB which are openable and closable. However, the targets to be operated by the robot system 1 are not limited to these. The robot system 1 may be used for any target objects that are operatable or movable. For example, the robot system 1 may be used for a target object that passively operates or moves by the application of external force. The robot system 1 may be used in various cases, such as a case where the robot system 1 operates or moves the target object by using the active robot and the passive arm 100 or 200, causes the passive arm 100 or 200 to maintain the state of the operated or moved target object, and causes the active robot to execute work or the like with respect to the target object.

In the embodiment, the robot system 1 includes the painting robots 300A and 300B that are industrial robots, and performs work related to industry. However, the present embodiment is not limited to this. For example, the robot system 1 may include a service robot and provide service to people. The service may be various types of service, such as care giving, medical care, cleaning, security, guidance, rescue, cooking, and product offerings.

In the embodiment, each of the controllers 500A to 500C of the robot system 1 causes the control targets, such as the painting robots 300A and 300B, the movers 410 to 440, and the locks 151 to 153, 251, and 252 of the passive arms 100 and 200, to operate by autonomous operation control. However, the embodiment is not limited to this. For example, each of the controllers 500A to 500C may cause one or more control targets to operate by manual operation control or a combination of the autonomous operation control and the manual operation control. For example, the manual operation control may be control of causing the control target to operate successively in accordance with an operation content input to an operating device by an operator. For example, in the manual operation control, the control target may execute an operation corresponding to the operation of the operator who operates the operating device.

In the embodiment, each of the locks 151 to 153, 251, and 252 uses the operating fluid, which is a gas or a liquid, as a power source and executes or releases locking by the supply or supply stop of the operating fluid. However, the present embodiment is not limited to this. The power source of the locks 151 to 153, 251, and 252 may be any power source. For example, each of the locks 151 to 153, 251, and 252 may use electric power as the power source and include an electric actuator used to execute or release locking.

In the embodiment, the controller 500A detects the coupling and uncoupling of the robot coupling 322A and the arm coupling 130 by using the detection signals of the first sensor 141, and the controller 500B detects the coupling and uncoupling of the robot coupling 322B and the arm coupling 230 by using the detection signals of the first sensor 241. However, the present embodiment is not limited to this. For example, the controller 500A may detect the above coupling and uncoupling based on changes in current values of the servomotors of the robotic arm 310A, and the controller 500B may detect the above coupling and uncoupling based on changes in current values of the servomotors of the robotic arm 310B. The controller 500A detects an insertion target, such as the gap VDa, and the completion of the insertion of the projection 122 into the insertion target by using the detection signals of the second sensor 142, and the controller 500B detects the insertion target, such as the opening of the holding tool Va, and the completion of the insertion of the projection 222 into the insertion target by using the detection signals of the second sensor 242. However, the present embodiment is not limited to this. For example, the controller 500A may detect contact or noncontact with the insertion target or its periphery based on the changes in the current values of the servomotors of the robotic arm 310A, and with this, may detect the insertion target and the completion of the insertion into the insertion target, and the controller 500B may detect contact or noncontact with the insertion target or its periphery based on the changes in the current values of the servomotors of the robotic arm 310B, and with this, may detect the insertion target and the completion of the insertion into the insertion target. In both cases, when the controller 500A detects the contact of the robot coupling 322A or the contact with the projection 122 based on the changes in the current values of the servomotors of the robotic arm 310A, the controller 500A may lower the gain of the servomotors to reduce the impact applied to the target object, and when the controller 500B detects the contact of the robot coupling 322B or the contact with the projection 222 based on the changes in the current values of the servomotors of the robotic arm 310B, the controller 500B may lower the gain of the servomotors to reduce the impact applied to the target object.

Examples of aspects of the technology of the present disclosure will be described below. A robot system according to one aspect of the present disclosure includes: a robotic arm; a passive arm with two or more degrees of freedom, the passive arm being coupled to and uncoupled from the robotic arm, the passive arm including an engaging structure that engages with a target object, the passive arm being operated by the robotic arm coupled to the passive arm; and a controller configured to control first and second operations of the robotic arm. The first operation of the robotic arm is an operation in which the robotic arm acts on the target object. The second operation of the robotic arm is an operation in which the robotic arm causes the passive arm to act on the target object. In the second operation, the controller executes: coupling the robotic arm and the passive arm; causing the robotic arm to operate the passive arm to engage the engaging structure with the target object; and causing the robotic arm to operate the passive arm, which has engaged with the target object, to operate the target object.

According to the above aspect, since the passive arm has two or more degrees of freedom, the passive arm can perform an operation of engaging with the target object and an operation of operating the target object. In the second operation, the controller can operate the robotic arm, which has been coupled to the passive arm, to cause the passive arm to engage with the target object and execute the operation of the target object. With the passive arm engaging with the target object, the controller can cause the robotic arm to uncouple the passive arm therefrom and perform the first operation with respect to the target object. With this, even when the engagement with the target object needs to be maintained, the robotic arm can perform the first operation with respect to the target object. Since the passive arm is operated by the robotic arm, each of the movable structures of the passive arm does not require a driving device, and therefore, the structure of the passive arm can be simplified. Therefore, when it is difficult for the robotic arm to perform work alone with respect to the target object, the robot system can cause the robotic arm to utilize the passive arm as the assist of the work. Since the arms of the robot system include not only the robotic arms as the active arms but also the passive arms, the cost reduction can be realized.

In the robot system according to one aspect of the present disclosure, the passive arm may include: two or more passive movable structures with the two or more degrees of freedom, the passive movable structures operating by application of external force to the passive arm; and two or more locks which lock operations of the passive movable structures by an action of an operating fluid. The locks may execute or release locking of the operations of the passive movable structures to hold or unhold a posture of the passive arm. The locks may release the locking while the operating fluid is supplied. The locks may execute the locking while the supply of the operating fluid stops. The controller may control the supply and supply stop of the operating fluid to the locks.

According to the above aspect, the controller can cause the passive arm to maintain its posture by causing the locks to lock the passive movable structures. For example, when the controller causes the passive arm to perform the operation of the target object, the controller may cause the locks to release the locking, and after the operation, may cause the locks to perform the locking. With this, the passive arm can maintain the state of the operated target object, and the controller can cause the robotic arm to perform the first operation with respect to the target object in the above maintained state. During the first operation, the contact between the robotic arm and the target object due to unintended operation of the target object is prevented. After the first operation is completed, the controller may cause the passive arm to operate, for example, return to an original state, and then, cause the locks to perform the locking. With this, the contact between the passive arm and the target object or between the passive arm and the robotic arm due to unintended operation of the passive arm is prevented.

Moreover, the passive arm does not include driving devices, such as motors, which drive the locks, and therefore, the structure of the passive arm can be simplified. For example, the passive arm may simply include piping through which the operating fluid is supplied to the locks. The controller may control the operation of a fluid control means, such as a valve that controls supply and supply stop of the operating fluid. A control system of the controller can be simplified.

Furthermore, when the locks release the locking, the operating fluid is supplied. When the locks perform the locking, the supply of the operating fluid stops. For example, in a use environment in which the period of time of the locking is longer than the period of time of the releasing of the locking, a load on, for example, the piping through which the operating fluid is supplied is suppressed to a low level. When the supply of the operating fluid stops at an unintended timing due to, for example, an abnormality of a supply source of the operating fluid, the locks perform the locking, and therefore, unintended operation of the passive arm is prevented.

The robot system according to one aspect of the present disclosure may further include: a first sensor that is located at one or both of the passive arm and the robotic arm and detects coupling between the passive arm and the robotic arm; and a second sensor that is located at the passive arm and detects an object existing in a predetermined direction. Based on a detection signal received from the first sensor, the controller may control an operation of the robotic arm for the coupling and uncoupling between the robotic arm and the passive arm. Based on a detection signal received from the second sensor, the controller may control an operation of the robotic arm by which the engaging structure engages with an engagement target.

According to the above aspect, the controller realizes the control of surely coupling the passive arm and the robotic arm and the control of surely uncoupling the passive arm and the robotic arm. The controller does not require complex position control of the robotic arm for the coupling and uncoupling between the passive arm and the robotic arm. Moreover, the controller realizes the control of surely engaging the engaging structure with the engagement target. The controller does not require complex position control of the robotic arm for the above engagement. Therefore, the control of the controller can be simplified.

The robot system according to one aspect of the present disclosure may further include: an arm mover that moves a position of the passive arm; and a robot mover that moves a position of the robotic arm. The controller may control operations of the arm mover and the robot mover. Based on information of the target object, the controller may control the operation of the arm mover such that the passive arm moves to a position associated with the target object, and controls the operation of the robot mover such that the robotic arm moves to a position associated with the target object.

According to the above aspect, the controller can change the position of the passive arm in accordance with the target object. For example, when the target object is moved by a manufacturing line, the controller can determine the position of the passive arm and move the passive arm to the determined position based on information of the position, speed, and the like of the target object which are included in the information of the target object. For example, the controller can move the passive arm such that the passive arm follows the moving target object.

Moreover, the controller can change the position of the robotic arm in accordance with the target object. For example, when the target object is moved by the manufacturing line, the controller can determine the position of the robotic arm and move the robotic arm to the determined position based on information of the position, speed, and the like of the target object which are included in the information of the target object. For example, the controller can move the robotic arm such that the robotic arm follows the moving target object.

In the robot system according to one aspect of the present disclosure, the target object may include an opening/closing part that is openable and closable, and the engaging structure may engage with the opening/closing part. According to the above aspect, the controller can use the robotic arm to cause the passive arm to open and close the opening/closing part.

The robot system according to one aspect of the present disclosure may further include: a first passive arm that is the passive arm which opens and closes a first opening/closing part as the opening/closing part; a second passive arm that is the passive arm which opens and closes a second opening/closing part as the opening/closing part; a first arm mover that moves a position of the first passive arm, and a second arm mover that moves a position of the second passive arm. The first opening/closing part may be openable and closable toward a lateral side. The second opening/closing part may be openable and closable in an upper-lower direction. Based on information of the target object, the controller may control operations of the first arm mover and the second arm mover such that the first passive arm and the second passive arm move to respective positions associated with the target object.

According to the above aspect, the controller can change the positions of the first and second passive arms in accordance with the position of the opening/closing part that is an action target of the target object. For example, when two or more opening/closing parts are the action targets for the first passive arm, the controller can move the first passive arm to the position of the opening/closing part to which an action should be applied, in accordance with the progress of the work of the robotic arm.

In the robot system according to one aspect of the present disclosure, the two or more passive movable structures may include: one or more advance/retreat movable structures that can advance and retreat; and one or more turning movable structures that are turnable. According to the above aspect, the degrees of freedom of the passive arm vary. With this, the size of the passive arm and the size of a region through which the passive arm passes during the operation can be reduced.

In the robot system according to one aspect of the present disclosure, an arm coupling of the passive arm to be coupled to the robotic arm may allow relative turning of the passive arm and the robotic arm while being coupled to a robot coupling of the robotic arm to be coupled to the passive arm. According to the above aspect, the robotic arm and the passive arm which are in a coupled state are turnable relative to each other at the robot coupling. Therefore, the configuration by which the passive arm operates so as to follow the operation of the robotic arm is simplified. The robot coupling and the arm coupling may be turnable or rotatable relative to each other, the robot coupling itself may be turnable or rotatable, or the arm coupling itself may be turnable or rotatable.

In the robot system according to one aspect of the present disclosure, the passive arm may include two or more passive movable structures with the two or more degrees of freedom, the passive movable structures operating by application of external force to the passive arm. The two or more passive movable structures may include one or more turning movable structures that are turnable. A turning axis direction of the robotic arm that turns relative to the passive arm at the robot coupling of the robotic arm coupled to the passive arm may be a direction along a turning axis direction of the turning movable structure. According to the above aspect, the size of the region through which the passive arm passes during the operation may be reduced in a direction intersecting with a turning axis of the robotic arm at the robot coupling and a turning axis of the turning movable structure. For example, a turning direction of the robotic arm at the robot coupling and an operating direction of the passive arm at the turning movable structure may be directions along the same flat plane.

In the robot system according to one aspect of the present disclosure, the passive arm may include: two or more passive movable structures with the two or more degrees of freedom, the passive movable structures operating by application of external force to the passive arm; three or more links coupled to each other through the two or more passive movable structures; and an end effector which is located at a tip of the passive arm and applies an action to the target object. An arm coupling of the passive arm to be coupled to the robotic arm may be located at the end effector.

According to the above aspect, by the robotic arm, the tip of the passive arm may be moved to a target position, a target posture, or a combination thereof. The tip of the passive arm moves so as to follow the operation of the robotic arm. Specifically, by the robotic arm, the end effector of the tip of the passive arm may be moved to a target position, a target posture, or a combination thereof. The end effector moves so as to follow the operation of the robotic arm. Therefore, the control of the operation of the passive arm by the robotic arm is facilitated.

In the robot system according to one aspect of the present disclosure, the passive arm may include an end effector which is located at a tip of the passive arm and applies an action to the target object, and the end effector may engage with an opening/closing part of the target object which is openable and closable. According to the above aspect, the passive arm can be operated by the robotic arm to engage the end effector with the opening/closing part and open or close the opening/closing part. With the passive arm opening or closing the opening/closing part, the robotic arm can perform the first operation with respect to the target object.

In the robot system according to one aspect of the present disclosure, the passive arm may include two or more passive movable structures with the two or more degrees of freedom, the passive movable structures operating by application of external force to the passive arm. The two or more passive movable structures may include: a first turning movable structure that is turnable; a second turning movable structure that is turnable; and an advance/retreat movable structure that advances and retreats. A turning axis direction of the first turning movable structure, a turning axis direction of the second turning movable structure, and an advance/retreat direction of the advance/retreat movable structure may be the same as each other. The passive arm may include: a first link coupled to the first turning movable structure; a second link coupling the first turning movable structure and the second turning movable structure; a third link coupling the second turning movable structure and the advance/retreat movable structure; a fourth link coupled to the advance/retreat movable structure; an end effector which is coupled to a tip of the fourth link and applies an action to the target object; and a biasing structure that biases the fourth link in a direction away from the advance/retreat movable structure in the advance/retreat direction. The first link may be located close to a base end of the passive arm. The fourth link may be located close to a tip of the passive arm. An arm coupling of the passive arm to be coupled to the robotic arm may be located at the end effector or the fourth link. The end effector may include: an extension extending in a direction intersecting with the advance/retreat direction; and a projection which projects from a tip of the extension in a direction toward the advance/retreat movable structure in the advance/retreat direction and engages with a recess or opening of the target object.

According to the above aspect, the passive arm can turn the second link and the third link in a direction perpendicular to the turning axis direction of the first turning movable structure and the turning axis direction of the second turning movable structure. The passive arm can move the fourth link relative to the third link in the above turning axis direction that is the advance/retreat direction of the advance/retreat movable structure. Therefore, the passive arm can move the fourth link in three-dimensional directions.

Moreover, when the external force is not applied, the fourth link is moved by the biasing structure to a predetermined position in a direction away from the advance/retreat movable structure in the advance/retreat direction. Since the passive arm applies an action to the target object by the end effector, the control of the operation of the passive arm by the robotic arm is easy.

Moreover, the robotic arm is coupled to the passive arm at the end effector or in the vicinity of the end effector. The end effector moves so as to follow the operation of the robotic arm. Therefore, the control of the operation of the robotic arm by which the end effector is moved to the target position, the target posture, or a combination thereof is facilitated.

Moreover, the end effector is movable in the projecting direction of the projection, and by this movement, the end effector can engage the projection with the recess or opening of the target object. Furthermore, since the projection is located at the tip of the extension, the contact between the end effector and the target object can be reduced. Therefore, the control of the operation of the robotic arm by which the end effector engages with the recess of the target object is facilitated.

In the robot system according to one aspect of the present disclosure, the passive arm may include two or more passive movable structures with the two or more degrees of freedom, the passive movable structures operating by application of external force to the passive arm. The two or more passive movable structures may include: an advance/retreat movable structure that advances and retreats; a first turning movable structure that is turnable; and a second turning movable structure that is turnable. The passive arm may include: a first link coupled to the advance/retreat movable structure; a second link coupling the advance/retreat movable structure and the first turning movable structure; a third link coupling the first turning movable structure and the second turning movable structure; and a fourth link coupled to the second turning movable structure. The first link may be located close to a base end of the passive arm. The fourth link may be located close to a tip of the passive arm. A turning axis direction of the first turning movable structure and a turning axis direction of the second turning movable structure may be the same as each other. An advance/retreat direction of the advance/retreat movable structure may be a direction intersecting with the turning axis direction of the first turning movable structure and the turning axis direction of the second turning movable structure.

According to the above aspect, the passive arm can move the entirety of the second to fourth links relative to the first link in the advance/retreat direction of the advance/retreat movable structure. The passive arm can turn the third link and the fourth link in a direction perpendicular to the turning axis direction of the first turning movable structure and the turning axis direction of the second turning movable structure. Therefore, the passive arm can cause the fourth link to perform various movements by the advancing and retreating of the second link and the turning of the third link and the fourth link.

In the robot system according to one aspect of the present disclosure, the third link may be a parallel link, and the third link may include: a first member coupling the first turning movable structure and the second turning movable structure; a second member extending along the first member and including one end coupled to the second link such that the second member is turnable; and a third member including one end coupled to another end of the second member such that the third member is turnable, the third member including another end coupled to the second turning movable structure such that the third member turns integrally with a fourth link. According to the above aspect, when the first member and the second member turn, the passive arm can maintain the fixed posture of the fourth link relative to the second link.

In the robot system according to one aspect of the present disclosure, the passive arm may further include a load structure which is coupled to the third link so as to move integrally with the third link. The load structure may be located at an opposite side of the third link across the first turning movable structure.

According to the above aspect, the load structure can apply to the third link a load in a turning direction about the first turning movable structure. For example, when the turning axis direction of the first turning movable structure is a horizontal direction, the third link receives from gravity an action in the turning direction which moves the second turning movable structure downward. However, the load structure may apply to the third link a load in a direction opposite to the turning direction. With this, force applied from the robotic arm to the passive arm in order to turn the third link is reduced, and the size and output of the robotic arm can be reduced. For example, the load structure may be a mass, such as a weight having a predetermined mass or more, or may be a biasing structure, such as a spring that applies biasing force to the third link.

In the robot system according to one aspect of the present disclosure, the passive arm may further include an end effector which is coupled to a tip of the fourth link and applies an action to the target object. An arm coupling of the passive arm to be coupled to the robotic arm may be located at the end effector or the fourth link. The end effector may include: an extension extending in a direction intersecting with a direction in which the fourth link extends; and a projection that projects from a tip of the extension in a direction from the end effector toward the fourth link and engages with a recess or opening of the target object.

According to the above aspect, the robotic arm is coupled to the passive arm at the end effector or in the vicinity of the end effector. The end effector moves so as to follow the operation of the robotic arm. Therefore, the control of the operation of the robotic arm by which the end effector is moved to a target position, a target posture, or a combination thereof is facilitated.

Moreover, the end effector can be moved in the projecting direction of the projection to engage the projection with the recess or opening of the target object. Since the projection is located at the tip of the extension, the contact between the end effector and the target object can be reduced. Therefore, the control of the operation of the robotic arm by which the end effector engages with the recess or opening of the target object is facilitated.

A control method according to one aspect of the present disclosure is a method of controlling a robot system including a robotic arm and a passive arm. The method includes: causing the robotic arm, which drives by itself, to operate to approach the passive arm; causing the robotic arm to operate to couple the robotic arm and the passive arm based on a detection signal of a first sensor that is located at one or both of the robotic arm and the passive arm and detects coupling between the robotic arm and the passive arm; causing two or more locks to release locking, the two or more locks being located at two or more movable structures of the passive arm with two or more degrees of freedom; causing the robotic arm to operate the passive arm to detect an engagement target of a target object, with which an engaging structure of the passive arm engages, based on a detection signal of a second sensor that is located at the passive arm and detects an object existing in a predetermined direction; causing the robotic arm to operate the passive arm to engage the engaging structure with the engagement target; causing the robotic arm to operate the passive arm, which has engaged with the engagement target, to operate the target object; causing the locks to lock the movable structures of the passive arm; and causing the robotic arm to operate based on the detection signal of the first sensor to uncouple the robotic arm and the passive arm.

According to the above aspect, the same effects as the robot system of the present disclosure are obtained. For example, the control method may be realized by circuitry, such as a CPU or a LSI, an IC card, a single module, or the like. The technology of the present disclosure may be a program for executing the above control method or may be a non-transitory, computer-readable recording medium that stores the above program. Needless to say, the above program is distributable through a transmission medium, such as the Internet.

A passive arm according to one aspect of the present disclosure includes: an arm body; and an arm coupling located at the arm body and coupled to a robot coupling of a robotic arm that drives by itself. The arm body includes two or more passive movable structures which give two or more degrees of freedom to the arm body, the passive movable structures operating by application of external force to the arm body. The arm coupling allows relative turning of the arm body and the robotic arm while being coupled to the robot coupling.

According to the above aspect, the robotic arm operates while being coupled to the arm body. With this, the robotic arm can cause the arm body to operate by two or more degrees of freedom. Each of the passive movable structures of such arm body does not require a driving device that operates the passive movable structure. Moreover, the robotic arm can be coupled to and uncoupled from the arm body. Therefore, when it is difficult for the robotic arm to perform work alone with respect to the target object, the passive arm can be utilized by the robotic arm according to need to assist the work by a simple configuration.

Moreover, the robotic arm and the arm body which are in a coupled state are turnable relative to each other at the robot coupling. Therefore, the configuration by which the arm body operates so as to follow the operation of the robotic arm is simplified. The robot coupling and the arm coupling may be turnable relative to each other, the robot coupling itself may be turnable, or the arm coupling itself may be turnable.

The functionality of the elements disclosed herein may be implemented using circuitry or processing circuitry which includes general purpose processors, special purpose processors, integrated circuits, ASICs, conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

All the numerals, such as the ordinal numbers and the quantities, are examples used to specifically describe the technology of the present disclosure, and the present disclosure is not limited to these numerals. Connection relations among the components are examples used to specifically describe the technology of the present disclosure, and the connection relations that realize the functions of the present disclosure are not limited to these.

The division of the blocks in the functional block diagram is one example. Plural blocks may be realized as one block, one block may be divided into plural blocks, some of the functions may be transferred to other blocks, or two or more of these may be combined with each other. Furthermore, the functions of plural blocks having similar functions may be processed by single hardware or software in parallel or in time division.

The scope of the present disclosure is defined by not the description but the claims attached hereto such that the present disclosure is carried out in various ways within the scope of the essential features of the present disclosure. Therefore, the exemplary embodiment and the modified examples thereof are exemplary embodiments and examples and are not limiting the present disclosure. All changes that come within the claims and the scope of the claims or equivalents in claims and the scope of the claims intend to be covered by the claims.

1. A robot system comprising:
a robotic arm including a robot end effector and a robot coupling, the robot end effector applying an action to a target object;
a passive arm with two or more degrees of freedom, the passive arm including an arm coupling coupled to and uncoupled from the robot coupling, the passive arm including an engaging structure that engages with the target object, the passive arm being operated by the robotic arm coupled to the arm coupling; and
a controller configured to control first and second operations of the robotic arm, wherein:
the first operation of the robotic arm is an operation in which the robotic arm causes the robot end effector to act on the target object;
the second operation of the robotic arm is an operation in which the robotic arm causes the passive arm to act on the target object; and
in the second operation, the controller executes
causing the robotic arm to couple the robot coupling and the arm coupling,
causing the robotic arm to operate the passive arm to engage the engaging structure with the target object, and
causing the robotic arm to operate the passive arm, which has engaged with the target object, to operate the target object.

2. The robot system according to claim 1, wherein:
the passive arm includes
two or more passive movable structures with the two or more degrees of freedom, the passive movable structures operating by application of external force to the passive arm, and
two or more locks which lock operations of the passive movable structures by an action of an operating fluid;
the locks execute or release locking of the operations of the passive movable structures to hold or unhold a posture of the passive arm;
the locks release the locking while the operating fluid is supplied,
the locks execute the locking while the supply of the operating fluid stops; and
the controller controls the supply and supply stop of the operating fluid to the locks.

3. The robot system according to claim 1 or 2, further comprising:
a first sensor that is located at one or both of the passive arm and the robotic arm and detects coupling between the arm coupling and the robot coupling; and
a second sensor that is located at the passive arm and detects an object existing in a predetermined direction, wherein:
based on a detection signal received from the first sensor, the controller controls an operation of the robotic arm for the coupling and uncoupling between the robot coupling and the arm coupling; and
based on a detection signal received from the second sensor, the controller controls an operation of the robotic arm by which the engaging structure engages with an engagement target.

4. The robot system according to any one of claims 1 to 3, further comprising:
an arm mover that moves a position of the passive arm; and
a robot mover that moves a position of the robotic arm, wherein:
the controller controls operations of the arm mover and the robot mover; and
based on information of the target object, the controller controls the operation of the arm mover such that the passive arm moves to a position associated with the target object, and controls the operation of the robot mover such that the robotic arm moves to a position associated with the target object.

5. (canceled)

6. The robot system according to any one of claims 1 to 4, further comprising:
a first passive arm that is the passive arm which opens and closes a first opening/closing part that is included in the target object and is openable and closable toward a lateral side;
a second passive arm that is the passive arm which opens and closes a second opening/closing part that is included in the target object and is openable and closable in an upper-lower direction;
a first arm mover that moves a position of the first passive arm; and
a second arm mover that moves a position of the second passive arm, wherein:
the engaging structure of the first passive arm engages with the first opening/closing part;
the engaging structure of the second passive arm engages with the second opening/closing part; and
based on information of the target object, the controller controls operations of the first arm mover and the second arm mover such that the first passive arm and the second passive arm move to respective positions associated with the target object.

7. The robot system according to any one of claims 1 to 4, and 6, wherein the arm coupling is coupled to the robot coupling such that the arm coupling and the robot coupling are turnable relative to each other.

8. The robot system according to claim 7, wherein:
the passive arm includes two or more passive movable structures with the two or more degrees of freedom, the passive movable structures operating by application of external force to the passive arm;
the two or more passive movable structures include one or more turning movable structures that are turnable; and
a turning axis direction of the arm coupling and a turning axis direction of the robot coupling with the arm coupling coupled to the robot coupling are along a turning axis direction of the turning movable structure.

9. The robot system according to any one of claims 1 to 4 and 6 to 8, wherein:
the passive arm includes
two or more passive movable structures with the two or more degrees of freedom, the passive movable structures operating by application of external force to the passive arm,
three or more links coupled to each other through the two or more passive movable structures, and
an arm end effector which is located at a tip of the passive arm and applies an action to the target object; and
the arm coupling is located at the arm end effector.

10. The robot system according to any one of claims 1 to 4 and 6 to 9, wherein:
the passive arm includes an arm end effector which is located at a tip of the passive arm and applies an action to the target object; and
the arm end effector engages with an opening/closing part of the target object which is openable and closable.

11. The robot system according to any one of claims 1 to 4 and 6 to 10, wherein:
the passive arm includes two or more passive movable structures with the two or more degrees of freedom, the passive movable structures operating by application of external force to the passive arm;
the two or more passive movable structures include
a first turning movable structure that is turnable,
a second turning movable structure that is turnable, and
an advance/retreat movable structure that advances and retreats;
a turning axis direction of the first turning movable structure, a turning axis direction of the second turning movable structure, and an advance/retreat direction of the advance/retreat movable structure are the same as each other;
the passive arm includes
a first link coupled to the first turning movable structure,
a second link coupling the first turning movable structure and the second turning movable structure,
a third link coupling the second turning movable structure and the advance/retreat movable structure,
a fourth link coupled to the advance/retreat movable structure,
an arm end effector which is coupled to a tip of the fourth link and applies an action to the target object, and
a biasing structure that biases the fourth link in a direction away from the advance/retreat movable structure in the advance/retreat direction;
the first link is located close to a base end of the passive arm;
the fourth link is located close to a tip of the passive arm;
the arm coupling is located at the arm end effector or the fourth link; and
the arm end effector includes
an extension extending in a direction intersecting with the advance/retreat direction and
a projection which projects from a tip of the extension in a direction toward the advance/retreat movable structure in the advance/retreat direction and engages with a recess or opening of the target object.

12. The robot system according to any one of claims 1 to 4 and 6 to 10, wherein:
the passive arm includes two or more passive movable structures with the two or more degrees of freedom, the passive movable structures operating by application of external force to the passive arm;
the two or more passive movable structures include
an advance/retreat movable structure that advances and retreats,
a first turning movable structure that is turnable, and
a second turning movable structure that is turnable;
the passive arm includes
a first link coupled to the advance/retreat movable structure,
a second link coupling the advance/retreat movable structure and the first turning movable structure,
a third link coupling the first turning movable structure and the second turning movable structure, and
a fourth link coupled to the second turning movable structure;
the first link is located close to a base end of the passive arm;
the fourth link is located close to a tip of the passive arm;
a turning axis direction of the first turning movable structure and a turning axis direction of the second turning movable structure are the same as each other; and
an advance/retreat direction of the advance/retreat movable structure is a direction intersecting with the turning axis direction of the first turning movable structure and the turning axis direction of the second turning movable structure.

13. The robot system according to claim 12, wherein:
the third link is a parallel link; and
the third link includes
a first member coupling the first turning movable structure and the second turning movable structure,
a second member extending along the first member and including one end coupled to the second link such that the second member is turnable, and
a third member including one end coupled to another end of the second member such that the third member is turnable, the third member including another end coupled to the second turning movable structure such that the third member turns integrally with the fourth link.

14. The robot system according to claim 12 or 13, wherein:
the passive arm further includes an arm end effector which is coupled to a tip of the fourth link and applies an action to the target object;
the arm coupling is located at the arm end effector or the fourth link; and
the arm end effector includes
an extension extending in a direction intersecting with a direction in which the fourth link extends, and
a projection that projects from a tip of the extension in a direction from the arm end effector toward the fourth link and engages with a recess or opening of the target object.

15. A method of controlling a robot system including a robotic arm and a passive arm,
the method comprising:
causing the robotic arm, which drives by itself, to operate to approach the passive arm, the robotic arm including a robot coupling and a robot end effector that applies an action to a target object, the passive arm including an arm coupling coupled to and uncoupled from the robot coupling;
causing the robotic arm to operate to couple the robot coupling and the arm coupling based on a detection signal of a first sensor that is located at one or both of the robotic arm and the passive arm and detects coupling between the robot coupling and the arm coupling;
causing two or more locks to release locking, the two or more locks being located at two or more movable structures of the passive arm with two or more degrees of freedom;
causing the robotic arm to operate the passive arm to detect an engagement target of the target object, with which an engaging structure of the passive arm engages, based on a detection signal of a second sensor that is located at the passive arm and detects an object existing in a predetermined direction;
causing the robotic arm to operate the passive arm to engage the engaging structure with the engagement target;
causing the robotic arm to operate the passive arm, which has engaged with the engagement target, to operate the target object;
causing the locks to lock the movable structures of the passive arm; and
causing the robotic arm to operate based on the detection signal of the first sensor to uncouple the robot coupling and the arm coupling.

16. A passive arm comprising:
an arm body; and
an arm coupling located at the arm body and coupled to a robot coupling of a robotic arm that drives by itself, the robotic arm including the robot coupling and a robot end effector that applies an action to a target object, wherein:
the arm body includes two or more passive movable structures which give two or more degrees of freedom to the arm body, the passive movable structures operating by application of external force to the arm body; and
the arm coupling allows relative turning of the arm body and the robotic arm while being coupled to the robot coupling.
